(19) United States
(12) Patent Application Publication
(10) Pub. No.: US 2018/0159132 A1
(43) Pub. Date: Jun. 7, 2018

(54) ANODE ACTIVE MATERIAL PARTICLES WITH ARTIFICIAL SEl-LAYER BY MEANS OF GRAFT-TO-POLYMERIZATION

(71) Applicant: Robert Bosch GmbH, Stuttgart (DE)

(72) Inventors: Andreas GONSER, Filderstadt-Plattenhardt (DE); Wilfried AICHELE, Winnenden (DE)

(21) Appl. No.: 15/821,289

(22) Filed: Nov. 22, 2017

(30) Foreign Application Priority Data
Dec. 2, 2016 (DE) 102016224039.0

(51) Int. Cl. H01M 4/62; H01M 10/0525; H01M 4/134; H01M 4/38; C08F 2/38

(52) U.S. Cl. CPC H01M 4/622; H01M 10/0525; C08F 2/38; H01M 4/386; H01M 4/134

(57) ABSTRACT

A method for manufacturing an anode active material and/or an anode for a lithium cell and/or lithium battery, in particular for a lithium-ion cell and/or lithium-ion battery, and/or for manufacturing such a lithium cell and/or lithium battery. In order to improve the cycle stability of the lithium cell and/or lithium battery, in the method at least one polymerizable monomer, and/or at least one polymer constituted from the at least one polymerizable monomer, is reacted with at least one silane compound having at least one polymerizable and/or polymerization-initiating and/or polymerization-controlling functional group, and anode active material particles, in particular silicon particles, are added. Also described is an anode active material, an anode, and a lithium cell and/or lithium battery.

### FIELD OF THE INVENTION

The present invention relates to a method for manufacturing an anode active material and/or an anode for a lithium cell and/or lithium battery, in particular for a lithium-ion cell and/or lithium-ion battery, and/or for manufacturing such a lithium cell and/or lithium battery, and to an anode active material and an anode, and to such a lithium cell and/or lithium battery.

### BACKGROUND INFORMATION

The anode active material principally used nowadays for lithium-ion cells and lithium-ion batteries is graphite. Graphite has only a low storage capacity, however.

Silicon can offer an appreciably higher storage capacity as an anode active material for lithium-ion cells and lithium-ion batteries. Silicon experiences large changes in volume upon cycling, however; the result can be that a solid electrolyte interphase (SEI) layer made of electrolyte decomposition products, which forms on the silicon surface, can break as the volume of the silicon increases and can flake off as the volume of the silicon decreases, so that with each cycle, electrolyte again comes into contact with the silicon surface, and SEI formation and electrolyte decomposition continuously proceed. This can result in an irreversible loss of lithium (and electrolyte) and thus in appreciably poorer cycle stability and capacity.

The document US 2014/0248543 A1 relates to nanostructured silicon active materials for lithium-ion batteries.

The document US 2014/0248543 A1 relates to a lithium-ion battery having an anode having at least one active material and having an electrolyte that encompasses at least one liquid polymer solvent and at least one polymer additive.

The document US 2015/0072246 A1 relates to a nonaqueous liquid electrolyte for a battery, which can encompass a polymerizable monomer as an additive.

The document US 2010/0273066 A1 discusses a lithium-air battery having a nonaqueous electrolyte, based on an organic solvent, which encompasses a lithium salt and an additive having an alkylene group.

The document US 2012/0007028 A1 relates to a method for manufacturing composite polymer-silicon particles, in which silicon particles and a monomer for forming a polymer matrix are mixed and the mixture is polymerized.

The document CN 104 362 300 relates to a method for manufacturing a composite silicon-carbon anode material for a lithium-ion battery.

The document US 2014/0342222 A1 relates to particles having a silicon core and a block copolymer shell, with one block having a relatively high affinity for silicon and with one block having a relatively low affinity for silicon.

H. Zhao et al. in J. Power Sources, 263, 2014, pp. 288-295 discusses the use of polymerized vinylene carbonate as an anode binder for lithium-ion batteries.

J.-H. Min et al. in Bull. Korean Chem. Soc., 2013, vol. 34, no. 4, pp. 1296-1299 describe the formation of an artificial SEI on silicon particles.

The document WO 2015/107581 relates to an anode material for batteries having nonaqueous electrolytes.

### SUMMARY OF THE INVENTION

The subject matter of the present invention is a method for manufacturing an anode active material and/or an anode for a lithium cell and/or lithium battery, in particular for a lithium-ion cell and/or lithium-ion battery, and/or for manufacturing a lithium cell and/or lithium battery, in particular a lithium-ion cell and/or lithium-ion battery.

In the method, in particular at least one polymerizable monomer and/or at least one polymer constituted from the at least one polymerizable monomer is reacted, for example polymerized, with at least one silane compound having at least one polymerizable and/or polymerization-initiating and/or polymerization-controlling functional group, and anode active material particles, in particular silicon particles, are, in particular then, added (graft-to polymerization).

“Anode active material particles” can be understood in particular as particles that encompass at least one anode active material.

The anode active material particles can, for example, encompass or be silicon particles and/or graphite particles and/or tin particles.

“Silicon particles” can be understood in particular as particles that encompass silicon. “Silicon particles” can be understood, for example, as particles that contain silicon. “Silicon particles” can therefore also be understood in particular as silicon-based particles. Silicon particles can, for example, encompass or be constituted from, in particular, pure or elemental silicon, for example porous silicon, for instance nanoporous silicon, for example having a pore size in the nanometer range, and/or nanosilicon, for example having a particle size in the nanometer range, and/or a silicon alloy matrix or a silicon alloy, for instance in which silicon is embedded in an active and/or inactive matrix, and/or a silicon-carbon composite and/or silicon oxide (SiOx). For instance, the silicon particles can be constituted from, in particular pure or elemental, silicon.

“Graphite particles” can be understood in particular as particles that encompass graphite.

“Tin particles” can be understood in particular as particles that encompass tin.

The anode active material particles can in particular encompass or be silicon particles.

The silane function of the at least one silane compound can advantageously attach, for example covalently, onto the surface of the anode active material particles, in particular silicon particles.

Because the at least one polymerizable monomer, and/or at least one polymer constituted from the at least one polymerizable monomer, is reacted with at least one silane compound having at least one polymerizable and/or polymerization-initiating and/or polymerization-controlling functional group, it is advantageously possible to constitute a polymer or copolymer, having a silane function, which upon addition of anode active material particles, in particular silicon particles, can enter via the silane function into an, in particular covalent and/or physical/mechanical, bond and/or attachment to the anode active material particle, in particular silicon particle (graft-to polymerization). It is thereby possible, for example, to achieve, for example, a covalent bond or linkage between the at least one monomer, or the polymer constituted therefrom, and the silane function, and via the silane function an, in particular direct, for example covalent, attachment or linkage to the anode active material particles, in particular silicon particles, and thereby to constitute a polymer layer having improved adhesion to the anode active material particles, in particular silicon particles.

For example, the at least one polymerizable functional group of the at least one silane compound can polymerize, for instance copolymerize, in particular with the at least one polymerizable monomer and/or with the at least one polymer constituted from the at least one polymerizable monomer. Copolymerization of the at least one silane compound having at least one polymerizable functional group and of the at least one polymerizable monomer advantageously allows formation of a copolymer, having a silane function, which can attach via the silane function, for example covalently, to the surface of the anode active material particles, in particular silicon particles. A silane compound having at least one polymerizable functional group can therefore advantageously serve as an adhesion promoter, in particular for the polymer layer constituted by polymerization onto the anode active material particles, in particular silicon particles, and can constitute a polymer layer having improved adhesion onto the anode active material particles, in particular silicon particles.

It is thereby advantageously possible to constitute on the anode active material particles, in particular silicon particles, an artificial SEI layer in the form a flexible polymeric protective layer having improved adhesion. Electrolyte decomposition and continuous SEI formation can advantageously be suppressed by way of this artificial SEI layer in the form of a flexible polymeric protective layer, since in the context of the changes in the volume of the anode active material particles, in particular silicon particles, during cycling, the flexible polymeric protective layer can respond during cycling, for example can be plastically extended and/or compressed, without thereby being destroyed, and can thereby passivate the particles, in particular silicon particles, and protect the anode active material surface, in particular silicon surface, from a reaction with electrolyte. The cycle stability (coulombic efficiency) of the lithium cell and/or lithium battery, for example in the form of a lithium-ion cell and/or lithium-ion battery, outfitted with the anode active material can thus in turn advantageously be enhanced.

The overall result is that, advantageously, an anode active material having elevated cycle stability and storage capacity can be furnished; with this, for example, inter alia the range of electric vehicles could also be increased.

In the context of an embodiment, at least two polymerizable monomers, and/or a copolymer constituted from at least two polymerizable monomers, are used in the method. For example, at least three polymerizable monomers, and/or a copolymer constituted from at least three polymerizable monomers, can be used in the method. By way of such copolymerization, in particular targeted copolymerization, of two, three, or more monomers, the desired properties, in particular of the artificial SEI layer, can advantageously be adjusted in targeted fashion and, for example, an adaptation or design of the SEI to or for its requirements can be achieved. It is thereby possible, for instance, to introduce polymer segments for binder reinforcement and/or for adaptation of the mechanical, for example rheological, properties, for instance strength and/or stretchability.

For instance, the polymerization can be a radical polymerization and/or polymerization by way of a condensation reaction and/or an ionic, for example anionic or cationic, polymerization.

For example, the polymerization can be a radical polymerization, and/or the at least one polymerizable functional group of the at least one silane compound can be polymerizable via radical polymerization and/or the at least one polymerizable monomer, in particular the at least two polymerizable monomers, can be polymerizable via radical polymerization, and/or the at least one polymerization-initiating functional group of the at least one silane compound can be configured to initiate a radical polymerization.

In particular, the polymerization can be a living radical polymerization, and/or the at least one polymerizable functional group of the at least one silane compound can be polymerizable via living radical polymerization and/or the at least one polymerizable monomer, in particular the at least two polymerizable monomers, can be polymerizable via living radical polymerization, and/or the at least one polymerization-initiating functional group of the at least one silane compound can be configured to initiate a living radical polymerization and/or the at least one polymerization-controlling functional group of the at least one silane compound can be configured to control a living radical polymerization.

Living radical polymerization is based on the principle that a dynamic equilibrium is generated between a relatively small number of active species, namely growth-promoting free radicals, and a large number of deactivated species. This can be achieved in particular by way of a radical buffer that is capable of capturing and re-releasing the active species, namely free radicals, in the form of a deactivated species. In particular, at least one radical buffer can therefore be used in polymerization. Irreversible chain-transfer and chain-terminating reactions, which in particular can result in a decrease in the number of active species and in a broadening of the molecular weight distribution, can thereby be greatly reduced. Living radical polymerization can also be referred to in particular as “living free radical polymerization” (LFRP) or controlled (free) radical polymerization (CFRP) or living controlled radical polymerization.

Examples of living radical polymerization are atom transfer (or atomic transfer) radical polymerization (ATRP), for instance using activators regenerated by electron transfer (ARGET-ATRP), reversible addition-fragmentation chain transfer polymerization (RAFT), stable free radical polymerization (SFRP), in particular nitroxide-mediated polymerization (NMP) and/or verdazyl-mediated polymerization (VMP), and iodine-transfer polymerization (ITP).

Living radical polymerization, in particular atom transfer living radical polymerization and/or stable free radical polymerization, for example nitroxide-mediated polymerization and/or verdazyl-mediated polymerization, in particular nitroxide-mediated polymerization, and/or reversible addition-fragmentation chain transfer polymerization, advantageously allows a narrow molecular weight distribution or low polydispersity (width of the molecular weight distribution) and/or improved control over the chain length of the polymer, and thereby, for example, a homogeneous polymer coating, to be achieved. The molecular weight distribution and/or polymer layer thickness can be adjusted in this context, for example, as a function of chemical concentrations, for instance monomer concentration, and/or reaction time and/or temperature.

The polymerization of the at least one polymerizable monomer, in particular of the at least two polymerizable monomers, can be initiated, for example, by way of, for example by addition of, the at least one polymerization-initiating functional group of the at least one silane compound, and/or by way of, for example by addition of, at least one polymerization initiator, in particular for initiating a radical polymerization, for example for initiating a living radical polymerization, for instance for initiating an atom transfer living radical polymerization and/or a stable free radical polymerization, for example a nitroxide-mediated polymerization and/or verdazyl-mediated polymerization, and/or a reversible addition-fragmentation chain transfer polymerization, for instance at least one radical initiator. It is thereby possible, advantageously, to initiate the polymerization in targeted fashion and to equip, in particular coat, the anode active material particles, in particular silicon particles, advantageously in targeted fashion, with the polymer constituted by polymerization. An artificial SEI layer in the form of a flexible polymeric layer made of the polymer constituted by polymerization can thereby advantageously be constituted on the anode active material particles, in particular silicon particles.

Polymerization of the at least one polymerizable monomer, in particular of the at least two polymerizable monomers, can be controlled, for example, by way of, for example by addition of, the at least one polymerization-controlling functional group of the at least one silane compound, and/or by way of, for example by addition of, at least one polymerization-controlling agent, in particular for controlling a living radical polymerization, for example for controlling a stable free radical polymerization, for example for controlling a nitroxide-mediated polymerization and/or for controlling a verdazyl-mediated polymerization, and/or for controlling a reversible addition-fragmentation chain transfer polymerization.

In the context of a further embodiment, the polymerization is an atom transfer living radical polymerization and/or the at least one polymerizable functional group of the at least one silane compound is polymerizable by way of an atom transfer living radical polymerization and/or the at least one polymerizable monomer, in particular the at least two polymerizable monomers, are polymerizable by way of an atom transfer living radical polymerization (ATRP) and/or the at least one polymerization-initiating functional group of the at least one silane compound is configured to initiate an atom transfer living radical polymerization (ATRP initiator). Atom transfer living radical polymerization advantageously allows a narrow molecular weight distribution or a low polydispersity (width of the molecular weight distribution) and/or improved control over the chain length of the polymer and, for example, thereby a homogeneous polymer coating, to be achieved.

The at least one polymerization-initiating functional group, in particular for initiating an atom transfer living radical polymerization, of the at least one silane compound can in particular be used in combination with at least one catalyst.

The at least one polymerization-initiating functional group of the at least one silane compound can encompass or be, for example, in particular for an atom transfer living radical polymerization (ATRP initiator), at least one halogen atom, for example chlorine (—Cl), bromine (—Br), or iodine (—I), which may be chlorine (—Cl) or bromine (—Br), for instance an alkyl group substituted with at least one halogen atom, for example chlorine (—Cl), bromine (—Br), or iodine (—I), which may be chlorine (—Cl) or bromine (—Br).

Alternatively or additionally, for that purpose the atom transfer living radical polymerization can also be initiated by way of, for example by addition of, at least one polymerization initiator for initiating an atom transfer living radical polymerization (ATRP initiator), in particular in combination with at least one catalyst. The at least one polymerization initiator can in particular encompass, or be constituted from, a alkyl halide. For instance, the at least one polymerization initiator can encompass or be methyl bromoisobutyrate and/or benzyl bromide and/or ethyl-a-bromophenylacetate.

The at least one catalyst can in particular encompass, or be constituted from, a transition metal halide, in particular a copper halide, for example copper chloride and/or copper bromide, for instance copper (I) bromide, and if applicable at least one ligand, for example at least one, in particular multidentate, nitrogen ligand (N-type ligand), for instance at least one amine, such as tris[2-(dimethylamino)ethyl]amine (Me6TREN) and/or tris(2-pyridylmethyl)amine (TPMA) and/or 2,2′-bipyridine and/or N,N,N′,N″,N″-pentamethyldiethylenetriamine (PMDETA) and/or 1,1,4,7,10,10-hexamethyltriethylenetetramine (HMTETA). For instance, the at least one catalyst can be a transition metal complex, in particular a transition metal-nitrogen complex.

The radical buffer or the deactivated species can be constituted from the at least one polymerization-initiating functional group of the at least one silane compound and/or from the alkyl halide, from the catalyst or complex, and from the monomer.

In the context of a further, alternative or additional embodiment, the polymerization is a stable free radical polymerization (SFRP), for example a nitroxide-mediated polymerization (NMP) and/or a verdazyl-mediated polymerization (VMP), in particular a nitroxide-mediated polymerization (NMP), and/or the at least one polymerizable functional group of the at least one silane compound is polymerizable by way of a stable free radical polymerization, for example nitroxide-mediated polymerization or verdazyl-mediated polymerization, in particular by nitroxide-mediated polymerization, and/or the at least one polymerizable monomer, in particular the at least two polymerizable monomers, are polymerizable by way of a stable free radical polymerization (SFRP), for example nitroxide-mediated polymerization (NMP) or verdazyl-mediated polymerization (VMP), in particular by nitroxide-mediated polymerization (NMP), and/or the at least one polymerization-controlling functional group of the at least one silane compound is configured to control a stable free radical polymerization (SFRP mediator), for example to control a nitroxide-mediated polymerization (NMP mediator) and/or to control a verdazyl-mediated polymerization (VMP mediator), in particular to control a nitroxide-mediated polymerization (NMP mediator).

The at least one polymerization-controlling functional group, in particular for controlling a stable free radical polymerization (SFRP mediator), for example for controlling a nitroxide-mediated polymerization (NMP mediator) and/or for controlling a verdazyl-mediated polymerization (VMP mediator), for example for controlling a nitroxide-mediated polymerization (NMP mediator), of the at least one silane compound can be used in particular in combination with at least one polymerization-initiating functional group of at least one silane compound and/or with a/the at least one polymerization initiator.

The at least one polymerization-controlling functional group of the at least one silane compound can encompass or be, in particular for a nitroxide-mediated polymerization (NMP mediator), for instance an, in particular linear or cyclic, nitroxide group and/or alkoxyamine group, for example based on 2,2,6,6-tetramethylpiperidinyloxyl (TEMPO):

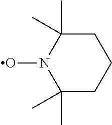

or a sacrificial initiator thereof, such as:

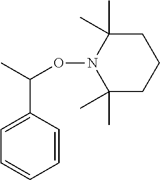 [SMILES: CC(ON1C(C)(C)CCCC1(C)C)c1ccccc1]

and/or on 2,2,5-trimethyl-4-phenyl-3-azahexane-3-oxyl (TIPNO):

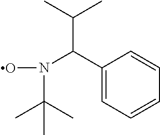

or a sacrificial initiator thereof, such as:

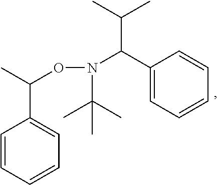 [SMILES: CC(ON(C(c1ccccc1)C(C)C)C(C)(C)C)c1ccccc1]

and/or on N-tertbutyl-N-[1-diethylphosphono-(2,2-dimethylpropyl)nitroxide] (SG1*):

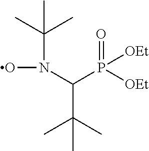

or a sacrificial initiator thereof.

Alternatively or additionally, for that purpose the stable free radical polymerization, for example nitroxide-mediated polymerization and/or verdazyl-mediated polymerization, can also be controlled by way of, for example by addition of, at least one polymerization-controlling agent for controlling a stable free radical polymerization, for example for controlling a nitroxide-mediated polymerization and/or for controlling a verdazyl-mediated polymerization, for instance at least one nitroxide-based mediator and/or at least one verdazyl-based mediator, in particular in combination with at least one polymerization-initiating functional group of at least one silane compound and/or with a/the at least one polymerization initiator. The at least one polymerization-controlling agent or the at least one nitroxide-based mediator can encompass or be, for example, an, in particular linear or cyclic, nitroxide. The at least one nitroxide-based mediator or the nitroxide can be based, for instance, on 2,2,6,6-tetramethylpiperidinyloxyl (TEMPO):

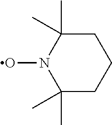

or a sacrificial initiator thereof, such as:

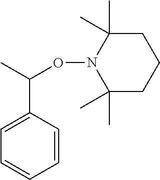 [SMILES: CC(ON1C(C)(C)CCCC1(C)C)c1ccccc1]

and/or on 2,2,5-trimethyl-4-phenyl-3-azahexane-3-oxyl (TIPNO):

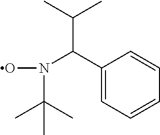

or a sacrificial initiator thereof, such as:

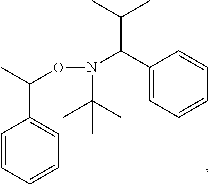 [SMILES: CC(ON(C(c1ccccc1)C(C)C)C(C)(C)C)c1ccccc1]

and/or on N-tertbutyl-N-[1-diethylphosphono-(2,2-dimethylpropyl)nitroxide] (SG1*):

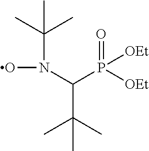

or a sacrificial initiator thereof.

The at least one polymerization initiator and/or the at least one polymerization-initiating functional group of the at least one silane compound can be configured in particular to initiate a stable free radical polymerization (SFRP initiator), for example to initialize a nitroxide-mediated polymerization (NMP initiator), and/or to initiate a verdazyl-mediated polymerization (VMP initiator), in particular to initiate a nitroxide-mediated polymerization (NMP initiator). The at least one polymerization initiator and/or the at least one polymerization-initiating functional group of the at least one silane compound can in particular encompass or be, in particular, a radical initiator, for instance an azoisobutyronitrile, for example azobisisobutyronitrile (AIBN), and/or a benzoyl peroxide, for example dibenzoyl peroxide (BPO), or a derivative thereof.

The radical buffer or the deactivated species can be formed in particular by reacting the active species, namely free radicals, with stable radicals based on the nitroxide group and/or alkoxyamine group or the nitroxide-based mediator.

In the context of a further, alternative or additional, embodiment, the polymerization is a reversible addition-fragmentation chain transfer polymerization (RAFT) and/or the at least one polymerizable functional group of the at least one silane compound is polymerizable by reversible addition-fragmentation chain transfer polymerization (RAFT), and/or the at least one polymerizable monomer, in particular the at least two polymerizable monomers, are polymerizable by reversible addition-fragmentation chain transfer polymerization (RAFT), and/or the at least one polymerization-controlling functional group of the at least silane compound is configured to control a reversible addition-fragmentation chain transfer polymerization (RAFT agent).

The at least one polymerization-controlling functional group, in particular for controlling a reversible addition-fragmentation chain transfer polymerization (RAFT agent), of the at least one silane compound can be used in particular in combination with at least one polymerization-initiating functional group of at least one silane compound and/or with a/the at least one polymerization initiator.

The at least one polymerization-controlling functional group of the at least one silane compound can encompass or be, in particular for a reversible addition-fragmentation chain transfer polymerization (RAFT agent), for instance a thio group, for example a trithiocarbonate group (—S—C═S—S—) or a dithioester group (—C═S—S—) or a dithiocarbamate group (—N—C═S—S—) or a xanthate group (—C═S—S⁻).

Alternatively or additionally, for that purpose the reversible addition-fragmentation chain transfer polymerization can also be controlled by way of, for example by addition of, at least one polymerization-controlling agent for controlling a reversible addition-fragmentation chain transfer polymerization (RAFT agent), for instance at least one thio compound, in particular in combination with at least one polymerization-initiating functional group of at least one silane compound and/or with a/the at least one polymerization initiator. The at least one polymerization-controlling agent or the at least one thio compound can be, for example, a trithiocarbonate or a dithioester or a dithiocarbamate or a xanthate.

The at least one polymerization initiator and/or the at least one polymerization-initiating functional group of the at least one silane compound can in particular be configured to initiate a reversible addition-fragmentation chain transfer polymerization (RAFT initiator). The at least one polymerization initiator and/or the at least one polymerization-initiating functional group of the at least one silane compound can in particular encompass or be in particular a radical initiator, for instance an azoisobutyronitrile, for example azobisisobutyronitrile (AIBN), and/or a benzoyl peroxide, for example dibenzoyl peroxide (BPO), or a derivative thereof.

The radical buffer or the deactivated species can be formed in particular by reacting the active species, namely free radicals, with stable radicals based on the thio group or the thio compound.

In the context of a further embodiment, the at least one silane compound encompasses at least one silane compound of the general chemical formula

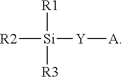

R1, R2, R3 can denote in particular, mutually independently in each case, a halogen atom, in particular chlorine (—Cl), or an alkoxy group, in particular a methoxy group (—OCH₃) or an ethoxy group (—OC₂H₅), or an alkyl group, for example a linear alkyl group (—(CH₂)ₓ—CH₃) where x≥0, in particular a methyl group (—CH₃), or an amino group (—NH₂, —NH—), or a silazane group (—NH—Si), or a hydroxy group (—OH), or hydrogen (—H). For instance, R1, R2, and R3 can denote chlorine.

Y can in particular denote a linker, i.e. a bridging unit. In particular, Y can denote at least one alkylene group (—CₙH₂ₙ—) where n≥1, and/or at least one alkylene oxide group (—CₙH₂ₙ—O—) where n≥1, and/or at least one carboxylic acid ester group (—C═O—O—), and/or at least one phenylene group (—C₆H₄—).

A can denote in particular a polymerizable and/or polymerization-initiating and/or polymerization-controlling functional group.

A silane compound having at least one polymerizable functional group can advantageously serve as an adhesion promotor.

In the context of a form of this embodiment, A denotes a polymerizable functional group. In particular, A can denote a polymerizable functional group having at least one polymerizable double bond. For example, A can denote a polymerizable functional group having at least one carbon-carbon double bond. For instance, A can denote a vinyl group or a vinylidene group or a vinylene group or an acrylate group or a methacrylate group.

An, in particular adhesion-promoting, silane compound having a polymerizable functional group can have, for example, the general chemical formula

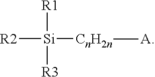

R1, R2, R3 can in particular, mutually independently in each case, denote a halogen atom, in particular chlorine (—Cl), or an alkoxy group, in particular a methoxy group (—OCH₃) or an ethoxy group (—OCH₂H₅), or an alkyl group, for example a linear alkyl group (—(CH₂)ₓ—CH₃) where x≥0, in particular a methyl group (—CH₃), or an amino group (—NH₂, —NH—), or hydrogen (—H). For example, SiR1R2R3 can denote a mono-, di- or trichlorosilane. In particular, A can denote a functional group having at least one carbon-carbon double bond, in particular a vinyl group or an acrylate group or a methacrylate group. It can be the case that 1≤n≤20, which may be 1≤n≤5, in particular n=2 or 3.

An example of an, in particular adhesion-promoting, silane compound having a polymerizable functional group is 3-(trichlorosilyl)propyl methacrylate:

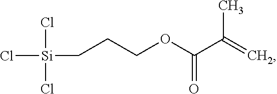

where in particular R1, R2, and R3 denote chlorine, A denotes methacrylate, and n=3.

In the context of another form of this embodiment, A denotes a polymerization-initiating functional group. In particular, A can denote a polymerization-initiating functional group for initiating an atom transfer living radical polymerization (ATRP initiator). In this context, A can in particular denote a halogen atom, for example chlorine (—Cl) or bromine (—Br) or iodine (—I), in particular chlorine (—Cl) or bromine (—Br).

A silane compound having a polymerization-initiating functional group, in particular for initiating an atom transfer living radical polymerization (ATRP initiator), can have, for example, the general chemical formula:

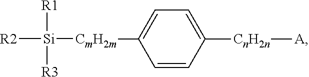

where R1, R2, R3 in particular can denote, mutually independently in each case, a halogen atom, in particular chlorine (—Cl), or an alkoxy group, in particular a methoxy group (—OCH₃) or an ethoxy group (—OCH₂H₅), or hydrogen (—H). For example, SiR1R2R3 can denote a mono-, di-, or trichlorosilane. In particular, A can denote a halogen atom, for example chlorine (—Cl), bromine (—Br), or iodine (—I), which may be chlorine (—Cl) or bromine (—Br). In this context, it can be the case that 1≤n≤20, which may be 1≤n≤5, in particular n=1 or 2, and/or that 0≤m≤20, which may be 0≤m≤5, in particular m=0 or 1 or 2.

An example of a silane compound having a polymerization-initiating functional group, in particular for initiating an atom transfer living radical polymerization (ATRP initiator), is trichloro[4-(chloromethyl)phenyl]silane or 4-(chloromethyl)phenyltrichlorosilane (CMPS):

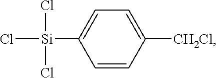

where in particular R1, R2, and R3, and A denotes chlorine, and n=1 and m=0.

In the context of another form of this embodiment, A denotes a polymerization-controlling functional group.

In the context of an embodiment, A denotes a polymerization-controlling functional group for nitroxide-mediated polymerization (NMP mediator). The polymerization-controlling functional group A can be, in particular, a nitroxide-based mediator. For instance, A can denote a nitroxide group and/or alkoxyamine group, for example based on 2,2,6,6-tetramethylpiperidinyloxyl (TEMPO) and/or on 2,2,5-trimethyl-4-phenyl-3-azahexane-3-oxyl (TIPNO) and/or on N-tertbutyl-N-[1-diethylphosphono-(2,2-dimethylpropyl)nitroxide] (SG1*).

Examples of silane compounds having a polymerization-controlling functional group, in particular for nitroxide-mediated polymerization (NMP mediator), are the 2,2,6,6-tetramethylpiperidinyloxyl (TEMPO)-based alkoxyamine-silane compound:

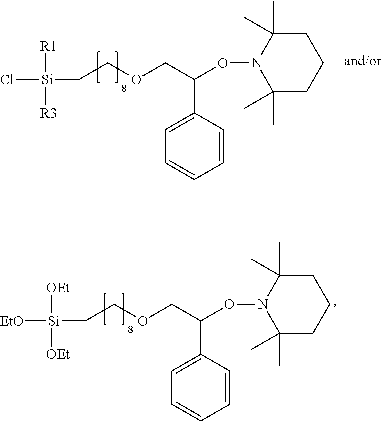

the 2,2,5-trimethyl-4-phenyl-3-azahexane-3-oxyl (TIPNO)-based alkoxyamine-silane compound of the formula:

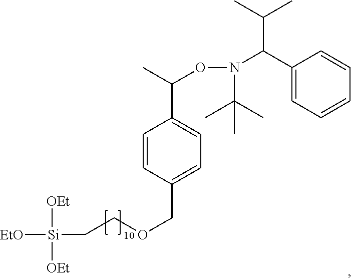

and/or the N-tertbutyl-N-[1-diethylphosphono-(2,2-dimethylpropyl)nitroxide] (SG1)-based alkoxyamine-silane compound of the formula:

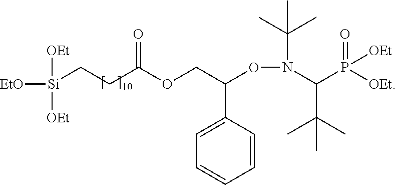

Instead of direct immobilization of at least one silane compound having at least one polymerization-controlling functional group for nitroxide-mediated polymerization (NMP mediator), anode active material particles, in particular silicon particles, can be functionalized for nitroxide-mediated polymerization by the fact that (firstly) at least one silane compound having at least one polymerizable functional group, for example 3-(trimethoxysilyl)propyl methacrylate, is immobilized on the surface of the anode active material particles, in particular silicon particles, and the at least one silane compound is (then) reacted with at least one nitroxide-based mediator, for example with at least one nitroxide compound or alkoxyamine compound, such as TEMPO, and, for example, with at least one polymerization initiator, in particular radical initiator, such as AIBN.

In the context of another embodiment, A denotes a polymerization-controlling functional group for reversible addition-fragmentation chain transfer polymerization (RAFT agent). The polymerization-controlling functional group can be, in particular, a thio group. For example, A can denote a trithiocarbonate group (—S—C═S—S—) or a dithioester group (—C═S—S—) or a dithiocarbamate group (—N—C═S—S—) or a xanthate group (—C═S—S⁻).

In a silane compound having a polymerization-controlling functional group, in particular for reversible addition-fragmentation chain transfer polymerization (RAFT agent), SiR1R2R3 can denote, for example, a chlorosilane, a methoxysilane, an ethoxysilane, or a silazane, and A can denote a dithioester or a dithiocarbamate or a trithiocarbonate or a xanthate.

Examples of silane compounds having a polymerization-controlling functional group, in particular for reversible addition-fragmentation chain transfer polymerization (RAFT agent), are the trithiocarbonate compound or dithioester compound:

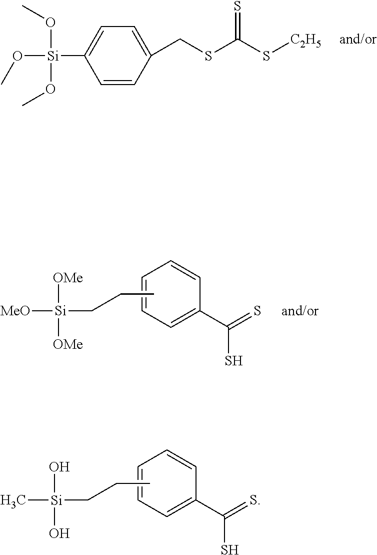

In the context of a further embodiment, the at least one silane compound encompasses at least one, in particular crown ether-based, silane compound of the general chemical formula:

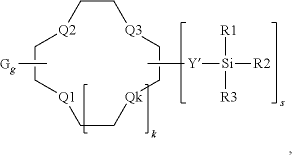

where Q1, Q2, Q3, and Qk can denote in particular, mutually independently in each case, oxygen (O) or nitrogen (N) or an amine, for example a secondary amine (NH) and/or a tertiary amine, for instance an alkylamine or arylamine (NR).

G can denote in particular at least one polymerizable functional group with which, for example, one of the carbon atoms and/or Q1 and/or Q2 and/or Q3 and/or Qk is substituted.

In particular, G can encompass at least one polymerizable double bond, for example at least one carbon-carbon double bond, for instance at least one vinyl group and/or vinylidene group and/or vinylene group and/or allyl group, for example allyoxyalkyl group, for instance allyloxymethyl group, and/or at least one hydroxy group, for example hydroxyalkylene group, for instance hydroxymethylene group.

G can furthermore encompass, for example, one or more further groups, which for example serve as linkers, i.e. a bridging unit or bridge segment. For instance, G can furthermore encompass at least one benzo group and/or cyclohexane group.

In particular, g can denote the number of polymerizable functional groups G, and in particular it can be the case that 1≤g≤5, for instance 1≤g≤2.

In particular, k can denote the number of units in brackets, and in particular it can be the case that 1≤k, for example 1≤k≤3, for instance 1≤k≤2.

Y′ can denote in particular a linker, i.e. a bridging unit. For example, Y′ can encompass at least one alkylene group (—CₙH₂ₙ—) where n≥0, in particular n≥1, and/or at least one alkylene oxide group (—CₙH₂ₙ—O—) where n≥1, and/or at least one carboxylic acid ester group (—C═O—O—), and/or at least one phenylene group (—C₆H₄—). For instance, Y′ can denote here an alkylene group —CₙH₂ₙ— where 0≤n≤5, for example n=1 or 2 or 3.

In particular, s can denote the number of silane groups (—SiR1R2R3), in particular those linked via linker Y′, and it can be the case in particular that 1≤s, for example 1≤s≤5, for instance 1≤s≤2.

R1, R2, R3 can in particular, mutually independently in each case, denote a halogen atom, in particular chlorine (—Cl), or an alkoxy group, in particular a methoxy group (—OCH₃) or an ethoxy group (—OC₂H₅), or an alkyl group, for example a linear alkyl group (—CH₂)ₓ—CH₃) where x≥0, in particular a methyl group (—CH₃), or an amino group (—NH₂, —NH—), or a silazane group (—NH—Si—), or a hydroxy group (—OH), or hydrogen (—H). For instance, R1, R2, and R3 can denote chlorine.

In particular, eQ1, Q2, Q3, and Qk can denote oxygen. For example, the at least one silane compound can encompass at least one, in particular crown ether-based, silane compound of the general chemical formula:

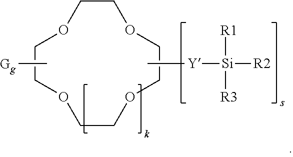

Examples of such, in particular crown ether-based, silane compounds are:

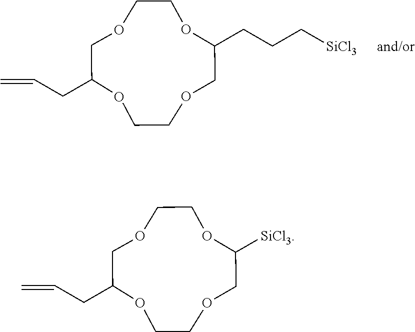

Such, in particular crown ether-based, silane compounds can advantageously attach to the surface of the anode active material particles, in particular silicon particles, advantageously via the silane group, in particular covalently, and for example additionally via van der Waals bonds and/or hydrogen bridge bonds, and can serve, for instance, as silane-based adhesion promoters.

The at least one silane compound having the at least one polymerizable functional group and/or the at least one polymerizable monomer can in particular encompass at least one ion-conductive or ion-conducting, in particular lithium-ion-conductive or lithium-ion-conducting, polymerizable monomer and/or at least one fluorinated polymerizable monomer, for example having at least one fluorinated alkyl group and/or at least one fluorinated alkoxy group and/or at least one fluorinated alkylene oxide group and/or at least one fluorinated phenyl group, and/or at least one polymerizable monomer for constituting a gel polymer, or can be ion-conductive or ion-conducting, in particular lithium-ion-conductive or lithium-ion-conducting, and/or can be fluorinated, and/or can be configured to constitute a gel polymer.

An “ion-conductive, for example lithium-ion-conductive” material, for example a monomer or polymer, can be understood in particular as a material, for example a monomer or polymer, that itself can be free of the ions to be conducted, for example lithium ions, but is suitable for coordinating and/or solvating the ions to be conducted, for example lithium ions, and/or counter-ions of the ions to be conducted, for instance lithium conducting salt anions, and becomes lithium-ion-conducting, for example, upon addition of the ions to be conducted, for instance lithium ions.

By polymerization of ion-conductive or ion-conducting and/or fluorinated and/or gel polymer-forming monomers, it is advantageously possible to constitute on the anode active material particles, in particular silicon particles, an artificial polymer-SEI protective layer that is configured to be ion-conductive or ion-conducting and/or fluorinated and/or configured to constitute a gel polymer. Thanks to ion-conductive or ion-conducting polymers and/or gel polymers, it is advantageously possible to achieve high efficiency in the cell or battery outfitted with the anode active material and to constitute, for example, an electrolyte coating or a gel electrolyte coating directly on the anode active material particles, in particular silicon particles. Fluorine-based polymers can exhibit high thermodynamic and, in particular, also electrochemical stability, and advantageously can be particularly stable in a potential window used in lithium-ion cells and/or lithium-ion batteries.

In the context of a further embodiment, the at least one polymerizable functional group of the at least one silane compound and/or the at least one polymerizable monomer encompasses or is, or the at least two, for example three, polymerizable monomers (each) encompass, at least one polymerizable double bond, for example at least one carbon-carbon double bond, in particular at least one vinyl group and/or at least one vinylene group and/or at least one vinylidene group and/or at least one allyl group, for example allyloxyalkyl group, for instance allyloxymethyl group, and/or at least one acrylate group and/or at least one methacrylate group and/or at least one phenylethene group (styrene group) and/or at least one hydroxy group. Polymerization can advantageously be achieved by way of these functional groups. In particular, the at least one polymerizable functional group of the at least one silane compound and/or the at least one polymerizable monomer can encompass or be, or the at least two, for example three, polymerizable monomers can (each) encompass or be, at least one polymerizable double bond, for example at least one carbon-carbon double bond, in particular at least one vinyl group and/or at least one vinylene group and/or at least one vinylidene group and/or at least one allyl group, for example allyloxyalkyl group, for instance allyloxymethyl group, and/or at least one acrylate group and/or at least one methacrylate group and/or at least one phenylethene group (styrene group). This has proven to be particularly advantageous for polymerization, in particular by way of living radical polymerization, such as ATRP, NMP, or RAFT. Thanks to at least one hydroxy group, the at least one polymerizable functional group of the at least one silane compound and/or the at least one polymerizable monomer or the at least two polymerizable monomers can be respectively polymerized or copolymerized via a condensation reaction or by anionic polymerization.

For instance, the at least one polymerizable functional group of the at least one silane compound can encompass or be at least one polymerizable double bond, for example at least one carbon-carbon double bond, for instance a vinyl group and/or a vinylidene group and/or a vinylene group and/or an acrylate group and/or a methacrylate group.

In the context of a further embodiment, the at least one polymerizable monomer (furthermore) encompasses at least one, in particular unfluorinated, alkylene oxide group, for example ethylene oxide group, for example polyalkylene oxide group, for instance polyethylene oxide group or polyethylene glycol group, and/or at least one fluorinated alkylene oxide group and/or at least one fluorinated alkoxy group and/or at least one fluorinated alkyl group and/or at least one fluorinated phenyl group.

Polymers that encompass alkylene oxide groups or are constituted from alkylene oxide monomers or are based on a polyalkylene oxide, such as polyethylene oxide (PEO) or polyethylene glycol (PEG), can advantageously be ion-conductive, for example lithium-ion-conductive. An ion-conductive, for example lithium-ion-conductive, artificial SEI protective layer, for example made from a polyethylene oxide (PEO) or polyethylene glycol (PEG), can thus advantageously be constituted on the particles. Polymers that have alkylene oxide groups or are based on a polyalkylene oxide, such as polyethylene oxide (PEO) or polyethylene glycol (PEG), can become ion-conducting, for example lithium-ion-conducting, in the presence of at least one conducting salt, for example lithium conducting salt. Anode active material particles, in particular silicon particles, that are equipped, in particular coated, with such polymers can come into contact with at least one conducting salt, for example lithium conducting salt, upon cell assembly or battery assembly and can thereby become ion-conducting, for example lithium-ion-conducting. In order to achieve high efficiency, and in particular high ionic conductivity, for the cell or battery outfitted with the anode active material, however, anode active material particles, in particular silicon particles, that are equipped, in particular coated in this fashion can in particular be treated, for example prior to cell assembly and/or battery assembly, with at least one conducting salt, for example lithium conducting salt, for instance lithium hexafluorophosphate (LiPF₆), bis(trifluoromethane)sulfonimide (LiTFSI), and/or lithium perchlorate (LiClO₄). In addition, such polymers can form a gel, for instance before or upon cell assembly and/or battery assembly, in the presence of at least one electrolyte solvent or of at least one liquid electrolyte, for example on the basis of a solution of at least one conducting salt in at least one electrolyte solvent, and can be used, for example, as a gel electrolyte. For instance, particles that are equipped, in particular coated, in this fashion can therefore be treated, for example before cell assembly and/or battery assembly, with at least one electrolyte solvent and/or with at least one conductive salt, for example made of at least one lithium conducting salt, for instance lithium hexafluorophosphate (LiPF₆), bis(trifluoromethane)sulfonimide (LiTFSI), and/or lithium perchlorate (LiClO₄), and at least one electrolyte solvent. In addition to an artificial SEI protective layer for passivation of the anode active material particles, in particular silicon particles, an electrolyte coating or a gel electrolyte coating can thereby advantageously be constituted directly on the anode active material particles, in particular silicon particles. In particular, however, if only the anode active material particles, in particular silicon particles, are coated with an electrolyte coating or gel electrolyte coating, the anode can furthermore encompass at least one, for instance carbonate-based, electrolyte, for example liquid electrolyte.

In the context of an alternative or additional embodiment, the at least one polymerizable monomer encompasses or is, or the at least two, in particular three, polymerizable monomers are selected from the group encompassing:
at least one polymerizable carboxylic acid, for example acrylic acid and/or methacrylic acid, and/or
at least one polymerizable carboxylic acid derivative, in particular
   at least one polymerizable organic carbonate, for example vinylene carbonate and/or vinyl ethylene carbonate, and/or anhydride, in particular at least one carboxylic acid anhydride, for example maleic acid anhydride, and/or
   at least one carboxylic acid ester, for example at least one acrylate, for instance at least one ether acrylate, for example poly(ethylene glycol) methyl ether acrylate, and/or at least one methacrylate, for example methyl methacrylate, and/or at least one acetate, for instance vinyl acetate, and/or
   at least one carboxylic acid nitrile, for example acrylonitrile, and/or
at least one, for example unfluorinated or fluorinated, ether, in particular at least one crown ether and/or at least one crown ether derivative and/or at least one vinyl ether, for instance trifluorovinyl ether, and/or
at least one, for example unfluorinated or fluorinated, alkylene oxide, for example ethylene oxide, and/or
at least one, for example aliphatic or aromatic, for instance unfluorinated or fluorinated, unsaturated hydrocarbon, for example at least one alkene, for instance ethene, such as 1,1-difluoroethene (1,1-difluoroethylene, vinylidene fluoride) and/or tetrafluoroethylene (TFE), and/or propene, such as hexafluoropropene, and/or hexene, such as 3,3,4,4,5,5,6,6,6-nonafluorohexene, and/or phenylethene, such as 2,3,4,5,6-pentafluorophenylethene (2,3,4,5,6-pentafluorostyrene), and/or 4-(trifluoromethyl)phenylethene (4-(trifluoromethyl)styrene), and/or styrene.

In the context of an embodiment, the at least one polymerizable monomer encompasses or is, or the at least two, in particular three, polymerizable monomers encompass, at least one polymerizable carboxylic acid.

In the context of a form of this embodiment, the at least one polymerizable monomer encompasses or is, or the at least two, in particular three, polymerizable monomers encompass, acrylic acid:

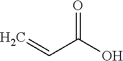

and/or a derivative thereon.

In the context of another, alternative or additional, form of this embodiment, the at least one polymerizable monomer encompasses or is, or the at least two, in particular three, polymerizable monomers encompass, methacrylic acid and/or a derivative thereof.

An artificial SEI protective layer made of a polymer based on polyacrylic acid or polymethacrylic acid can be constituted on the particles by polymerization respectively of acrylic acid or methacrylic acid. The polymer based respectively on polyacrylic acid or polymethacrylic acid can attach via carboxylic acid groups (—COOH) to hydroxy groups, for example silicon hydroxide groups or silanol groups (Si—OH), onto the surface of the anode active material particles, in particular silicon particles, for example covalently via a condensation reaction and/or via hydrogen bridge bonds. In addition to passivation of the particles by way of a protective layer made of the polymer based on polyacrylic acid or polymethacrylic acid, the polymer based on polyacrylic acid or polymethacrylic acid can advantageously serve as a binder reinforcement and/or a binder, and the binding property of the anode active material can thereby be improved. Because the polymer based on polyacrylic acid or polymethacrylic acid is produced in the presence of the anode active material particles, in particular silicon particles, it is moreover advantageously possible to constitute a more homogeneous mixture than is possible by mixing polyacrylic acid or polymethacrylic acid, produced ex situ, into anode active material particles, in particular silicon particles.

In the context of a further embodiment, the polymer constituted from the at least one polymerizable monomer, in particular its carboxylic acid groups, is neutralized at least in part with at least one alkali metal hydroxide, for example lithium hydroxide (LiOH) and/or sodium hydroxide (NaOH) and/or potassium hydroxide (KOH), in particular forming an alkali metal carboxylate, for example respectively a lithium carboxylate or sodium carboxylate or potassium carboxylate. It is thereby possible to improve the rheological properties and/or minimize an irreversible capacity loss, in particular in the first cycle of a cell or battery outfitted with the anode active material.

In the context of an alternative or additional further embodiment, the at least one polymerizable monomer encompasses or is, or the at least two, in particular three, polymerizable monomers encompass, at least one polymerizable carboxylic acid derivative.

In the context of a further embodiment, the at least one polymerizable monomer encompasses or is, or the at least two, in particular three, polymerizable monomers encompass, at least one polymerizable organic carbonate and/or anhydride, in particular at least one carboxylic acid anhydride. In particular, the at least one polymerizable monomer can encompass or be at least one polymerizable organic carbonate. Organic carbonates have proven to be particularly advantageous for constituting an artificial SEI layer. Organic carbonates furthermore can advantageously be ion-conductive, in particular lithium-ion-conductive.

In the context of a further embodiment, the at least one polymerizable monomer encompasses or is vinylene carbonate and/or vinyl ethylene carbonate and/or maleic acid anhydride and/or a derivative thereof. This has proven to be advantageous for the constitution of an, in particular ion-conductive, for example lithium-ion-conductive, artificial SEI layer.

In the context of a special form of this embodiment, the at least one polymerizable monomer encompasses or is vinylene carbonate. Polymerization of vinylene carbonate allows the formation in particular of polyvinylene carbonate, which has proven to be particularly advantageous for an artificial SEI layer.

In the context of an alternative or additional further embodiment, the at least one polymerizable monomer encompasses or is, or the at least two, in particular three, polymerizable monomers encompass, at least one carboxylic acid ester.

For example, the at least one polymerizable monomer or the at least two, in particular three polymerizable monomers, can respectively encompass or be at least one acrylate, for instance at least one ether acrylate, such as poly(ethylene glycol) methyl ether acrylate, for example:

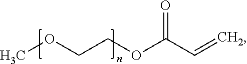

and/or at least one methacrylate, for example methyl methacrylate, and/or at least one acetate, for instance vinyl acetate, and/or a derivative thereof.

The polymerization of acrylates, for instance ether acrylates, such as poly(ethylene glycol) methyl ether acrylate, and/or methacrylates, such as methyl methacrylate (MMA), allows an artificial SEI protective layer, made of a polymer based on polyacrylate or polymethyl methacrylate, to be constituted on the particles. Polymers based on polyacrylate, for instance ether acrylate-based polymers or polymethyl methacrylates, can advantageously form a gel, for instance in the context of cell assembly and/or battery assembly, in the presence of at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), or of at least one liquid electrolyte, for example based on a, for example 1M, solution of at least one conducting salt, for instance lithium hexafluorophosphate (LiPF₆) and/or bis(trifluoromethane)sulfonimide (LiTFSI) and/or lithium perchlorate (LiClO₄) in at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), and can be used, for example, as a gel electrolyte. It is thereby advantageously possible to constitute, in addition to an artificial SEI protective layer for passivating the anode active material particles, in particular silicon particles, a gel electrolyte coating directly on the anode active material particles, in particular silicon particles. In a first cycle of a cell or battery outfitted therewith, the electrolyte can decompose in the polymer gel matrix of the gel electrolyte coating and can mechanically stabilize the, in particular artificial or naturally occurring, SEI protective layer. This advantageously makes it possible, in the context of cell assembly and/or battery assembly, to dispense with the addition of SEI-stabilizing additives, such as vinylene carbonate (VC) or fluoroethylene carbonate (FEC), in particular to the liquid electrolyte. Polymers based on ether acrylates, such as poly(ethylene glycol) methyl ether acrylate, can furthermore be ion-conductive, for example lithium-ion-conductive, and can become ion-conducting, for example lithium-ion-conducting, in the presence of at least one conducting salt, for example lithium conducting salt, for example by being brought into contact with at least one conducting salt, for example lithium conducting salt, in the context of cell assembly or battery assembly. In order to achieve high efficiency, and in particular high ionic conductivity, for the cell or battery outfitted with the anode active material, however, anode active material particles, in particular silicon particles, that are equipped, in particular coated, therewith, can be treated, for example prior to cell assembly and/or battery assembly, with at least one conducting salt, for example lithium conducting salt, for instance lithium hexafluorophosphate (LiPF₆), bis(trifluoromethane)sulfonimide (LiTFSI), and/or lithium perchlorate (LiClO₄)

As a result of the polymerization of vinyl acetate, an artificial SEI protective layer made of a polymer based on polyvinyl acetate (PVAC) can be constituted on the particles. The polyvinyl acetate-based polymer can then be saponified to yield, for example, polyvinyl alcohol (PVAL). In order to prevent secondary reactions with other electrode components, the polymerization of the at least one polymerizable monomer, and in particular the saponification of the polymer constituted in that context, can for example be carried out separately from further electrode components. The polyvinyl alcohol-based polymer can advantageously attach via hydroxy groups (—OH), for example via silicon hydroxide groups or silanol groups (Si—OH), to the surface of the anode active material particles, in particular silicon particles, for example covalently via a condensation reaction and/or via hydrogen bridge bonds. In addition to passivation of the particles by way of a protective layer of the polyvinyl alcohol-based polymer, the polyvinyl alcohol-based polymer can advantageously serve as a binder intensifier or binder, and the binding property of the anode active material can thereby be improved. Because the polyvinyl alcohol-based polymer is manufactured in the presence of the anode active material particles, in particular silicon particles, it is moreover advantageously possible to constitute a more homogeneous mixture than is possible by mixing polyvinyl alcohol, manufactured ex situ, into anode active material particles, in particular silicon particles.

In the context of an alternative or additional further embodiment, the at least one polymerizable monomer encompasses or is, or the at least two, in particular three, polymerizable monomers encompass, at least one carboxylic acid nitrile. For example, the at least one polymerizable monomer, or the at least two, in particular three, polymerizable monomers, can encompass or be acrylonitrile and/or a derivative thereof. A artificial SEI protective layer made of a polymer based on polyacrylonitrile (PAN) can be constituted on the particles by polymerization of acrylonitrile. Polymers based on polyacrylonitrile (PAN) can advantageously form a gel, for instance in the context of cell assembly and/or battery assembly, in the presence of at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), or of at least one liquid electrolyte, for example based on a, for example 1M, solution of at least one conducting salt, for instance lithium hexafluorophosphate (LiPF₆) and/or bis(trifluoromethane)sulfonimide (LiTFSI) and/or lithium perchlorate (LiClO₄) in at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), and can be used, for example, as a gel electrolyte. It is thereby advantageously possible to constitute, in addition to an artificial SEI protective layer for passivating the anode active material particles, in particular silicon particles, a gel electrolyte coating directly on the anode active material particles, in particular silicon particles. In a first cycle of a cell or battery outfitted therewith, the electrolyte can decompose in the polymer gel matrix of the gel electrolyte coating and can mechanically stabilize the, in particular artificial or naturally occurring, SEI protective layer. This advantageously makes it possible, in the context of cell assembly and/or battery assembly, to dispense with the addition of SEI-stabilizing additives, such as vinylene carbonate (VC) or fluoroethylene carbonate (FEC), in particular to the liquid electrolyte.

In the context of an alternative or additional further embodiment, the at least one polymerizable monomer encompasses or is, or the at least two, in particular three, polymerizable monomers encompass, at least one, for example unfluorinated or fluorinated, ether. In particular, the at least one polymerizable monomer or the at least two, in particular three, polymerizable monomers can encompass or be at least one, for example unfluorinated or fluorinated, ether having at least one polymerizable functional group, in particular having at least one polymerizable double bond, for example having at least one carbon-carbon double bond, for instance having at least one vinyl group and/or allyl group and/or allyloxyalkyl group, for example allyloxymethyl group, and/or having at least one hydroxy group, for example alkylene hydroxy group, for instance hydroxymethylene group.

For example, the at least one polymerizable monomer or the at least two, in particular three, polymerizable monomers can encompass or be at least one crown ether and/or at least one crown ether derivative and/or at least one vinyl ether, for example trifluorovinyl ether.

In particular, the at least one polymerizable monomer or the at least two, in particular three, polymerizable monomers can encompass or be at least one crown ether and/or at least one crown ether derivative.

For example, the at least one polymerizable monomer or the at least two, in particular three, polymerizable monomers can encompass or be at least one crown ether and/or at least one crown ether derivative having at least one polymerizable functional group, in particular having at least one polymerizable double bond, for example having at least one carbon-carbon double bond, for instance having at least one vinyl group and/or at least one vinylidene group and/or at least one vinylene group and/or at least one allyl group, for example allyloxyalkyl group, and/or at least one acrylate group and/or at least one methacrylate group, for example having at least one carbon-carbon double bond, for instance having at least one vinyl group and/or at least one vinylidene group and/or at least one vinylene group and/or at least one allyl group, for example allyloxyalkyl group, for instance allyloxymethyl group, and/or having at least one hydroxy group, for example hydroxyalkylene group, for instance hydroxymethylene group.

The at least one polymerizable functional group of the at least one crown ether and/or crown ether derivative can be attached, for example, directly to the crown ether or crown ether derivative. For steric reasons in particular, however, it may also possibly be advantageous to provide between the crown ether or crown ether derivative and the at least one polymerizable functional group, for example additionally, a linker or a bridge segment, such as a benzene ring or cyclohexane ring. By polymerization of the at least one polymerizable double bond, in particular carbon-carbon double bond, it is possible in particular to constitute a polymer backbone, for example a C—C backbone, which exhibits, for instance, a crown ether-based functionality at every second carbon atom.

The polymerization of crown ethers and/or crown ether derivatives having polymerizable functional groups allows the constitution of an artificial SEI protective layer, made of a polymer that is based on crown-ether basic modules, on the particles. Polymers based on crown ethers can be, in particular selectively, ion-conductive, in particular lithium-ion-conductive, and advantageously offer optimum diffusion paths for alkali metal ions, in particular lithium ions.

Crown ethers and/or crown ether derivatives furthermore can advantageously attach to the surface of the anode active material particles, in particular silicon particles, at least via van der Waals bonds and/or hydrogen bridge bonds, and thereby improve the adhesion of the polymer layer constituted therefrom onto the anode active material particles, in particular silicon particles.

The at least one crown ether and/or the at least one crown ether derivative can be polymerizable, and/or polymerized or copolymerized, for example by radical polymerization, for instance living radical polymerization, such as atom transfer living radical polymerization (ATRP) and/or stable free radical polymerization (SFRP), for example nitroxide-mediated polymerization (NMP) and/or verdazyl-mediated polymerization (VMP), and/or reversible addition-fragmentation chain transfer polymerization (RAFT), and/or polymerization via a condensation reaction and/or via ionic, for example anionic or cationic, polymerization.

For instance, the at least one polymerizable functional group of the at least one crown ether and/or crown ether derivative can encompass or be at least one polymerizable double bond, for example at least one carbon-carbon double bond, in particular at least one vinyl group and/or at least one vinylene group and/or at least one vinylidene group and/or at least one allyl group, for example allyloxyalkyl group, for instance allyloxymethyl group, and/or at least one acrylate group and/or at least one methacrylate group and/or at least one phenylethene group (styrene group), and/or at least one hydroxy group. Polymerization can advantageously be achieved by way of these functional groups. For example, the at least one polymerizable functional group of the at least one crown ether and/or crown ether derivative can encompass or be at least one vinyl group and/or at least one vinylene group and/or at least one vinylidene group and/or at least one allyl group, for example allyloxyalkyl group, for instance allyloxymethyl group, and/or at least one acrylate group and/or at least one methacrylate group and/or at least one hydroxy group, in particular hydroxyalkylene group. By way of at least one hydroxy group, the at least one polymerizable functional group of the at least one crown ether and/or crown ether derivative can be polymerized or copolymerized via a condensation reaction or by anionic polymerization. For instance, the at least one polymerizable functional group of the at least one crown ether and/or crown ether derivative can encompass or be at least one polymerizable double bond, for example at least one carbon-carbon double bond, in particular at least one vinyl group and/or at least one vinylene group and/or at least one vinylidene group and/or at least one allyl group, for example allyloxyalkyl group, for instance allyloxymethyl group, and/or at least one acrylate group and/or at least one methacrylate group and/or at least one phenylethene group (styrene group). This has proven to be particularly advantageous for polymerization, in particular via living radical polymerization such as ATRP, NMP, or RAFT.

The at least one crown ether and/or the at least one crown ether derivative, and/or the polymer encompassing at least one crown ether and/or crown ether derivative, can furthermore have, in particular in addition to the at least one polymerizable functional group, at least one silane group. Thanks to the at least one silane group, the at least one crown ether and/or the at least one crown ether derivative, and/or the polymer encompassing at least one crown ether and/or crown ether derivative, can advantageously attach, for example covalently, to the surface of the anode active material particles, in particular silicon particles. A polymer layer having improved adhesion can thereby advantageously be constituted.

In particular, the at least one crown ether and/or the at least one crown ether derivative can encompass, or can be based on, a crown ether, in particular

a 12-crown-4 ether:

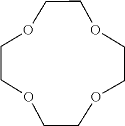 [SMILES: C1COCCOCCOCCO1]

and/or a a 15-crown-5 ether:

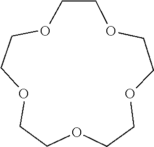 [SMILES: C1COCCOCCOCCOCCO1]

and/or an aza-crown ether, for example a (di-)aza crown ether, for example an aza-12-crown-4 ether, for instance a 1-aza-12-crown-4 ether, for instance:

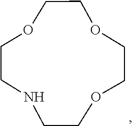 [SMILES: C1COCCOCCOCCN1]

and/or an aza-15-crown-5 ether, for example a di-aza crown ether, for instance a di-aza-12-crown-4 ether and/or a di-aza-15-crown-5 ether, for instance:

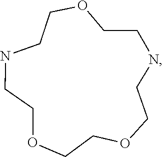

and/or an, in particular N-substituted, (di-)aza crown ether, for example an N-alkyl-(di-)aza-12-crown-4 ether and/or N-alkyl-(di-)aza-15-crown-5 ether, and/or a benzo-crown ether, in particular a benzo-12-crown-4 ether and/or benzo-15-crown-5 ether, for instance:

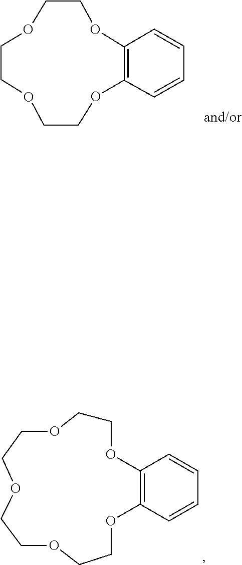 [SMILES: c1ccc2c(c1)OCCOCCOCCO2 ; c1ccc2c(c1)OCCOCCOCCOCCO2]

for example a di-benzo-crown ether, for instance a di-benzo-12-crown-4 ether, for instance:

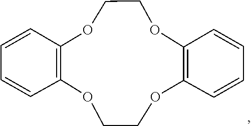 [SMILES: c1ccc2c(c1)OCCOc1ccccc1OCCO2]

and/or a di-benzo-15-crown-5 ether, and/or a cyclohexano-crown ether, in particular a cyclohexano-12-crown-4 ether and/or cyclohexano-15-crown-5 ether, for example a dicyclohexano-crown ether, for instance a dicyclohexano-12-crown-4 ether, for instance:

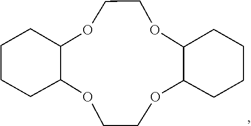 [SMILES: C1CCC2OCCOC3CCCCC3OCCOC2C1]

and/or a dicyclohexano-15-crown-5 ether.

In the context of a form of this embodiment, the at least one crown ether and/or the at least one crown ether derivative encompasses respectively a crown ether or crown ether derivative of the general chemical formula:

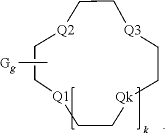

Q1, Q2, Q3, and Qk here can in particular denote, mutually independently in each case, oxygen (O) or nitrogen (N) or an amine, for example a secondary amine (NH) and/or a tertiary amine, for instance an alkylamine or arylamine (NR).

G can denote in particular at least one polymerizable functional group, for example with which one of the carbon atoms and/or Q1 and/or Q2 and/or Q3 and/or Qk is substituted.

In particular, g can denote the number of polymerizable functional groups G, and it can be the case in particular that 1≤g, for example 1≤g≤5, for instance 1≤g≤2.

In particular, k can denote the number of units in brackets, and it can be the case in particular that 1≤k, for example 1≤k≤3, for instance 1≤k≤2.

In particular, G can encompass at least one polymerizable double bond, for example at least one carbon-carbon double bond, for instance at least one vinyl group and/or at least one vinylidene group and/or at least one vinylene group and/or at least one allyl group, for example allyloxyalkyl group, for instance allyloxymethyl group, and/or at least one hydroxy group, for example hydroxyalkylene group, for instance hydroxymethylene group.

Furthermore, G can encompass one or more further groups, which serve for example as linkers, i.e. a bridging unit or bridge segment. For instance, G can furthermore encompass at least one benzo group and/or cyclohexano group.

In particular, Q1, Q2, Q3, and Qk can denote oxygen. For example, the at least one crown ether and/or the at least one crown ether derivative can encompass respectively a crown ether or crown ether derivative of the general chemical formula:

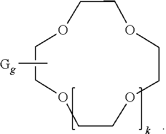

For instance, the at least one crown ether and/or the at least one crown ether derivative can encompass respectively a crown ether or a crown ether derivative of the general chemical formula:

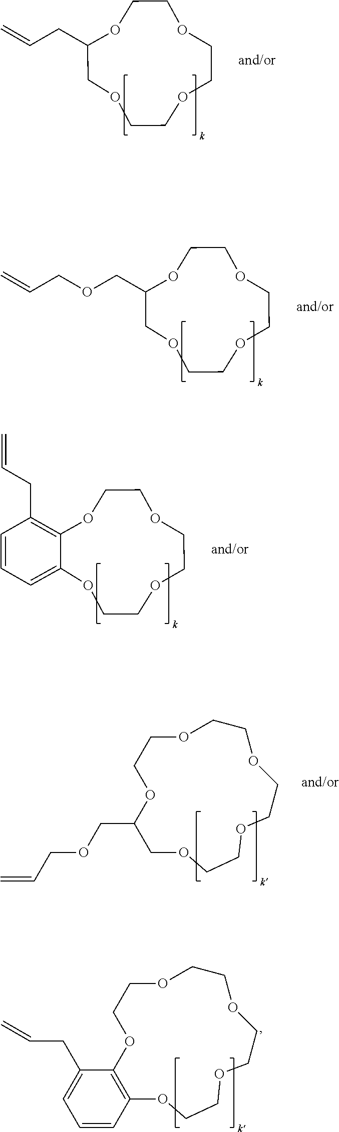

where in particular 0≤k′, for example 0≤k′≤2, for instance 0≤k′≤1.

By polymerization, for example living radical polymerization, of the double bonds, it is possible to constitute polymers having a carbon-carbon (C—C) polymer backbone and crown-ether or crown ether-derivative side groups, for instance:

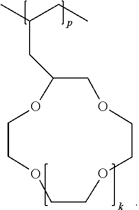

Alternatively or in addition thereto, it is also possible, for example, to constitute polymers having crown-ether or crown ether-derivative groups, in particular directly, in the polymer backbone or the polymer chain. This can be possible, for example, by polymerization, for example via a condensation reaction, for instance etherification, of (di-)benzo- and/or (di-)cyclohexano-crown ethers and/or -crown ether derivatives, for example having at least two, optionally four, hydroxy groups, for instance on the benzo and/or cyclohexano rings.

For example, the at least one crown ether and/or the at least one crown ether derivative can encompass respectively a crown ether or a crown ether derivative of the general chemical formula:

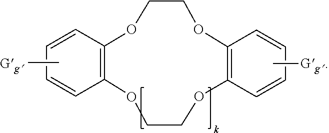

G′ can denote in particular at least one polymerizable functional group. In particular, G′ can encompass at least one polymerizable double bond, for example at least one carbon-carbon double bond, for instance at least one vinyl group and/or at least one vinylidene group and/or at least one vinylene group and/or at least one allyl group, for example allyloxyalkyl group, for instance allyloxymethyl group, and/or at least one hydroxy group, for example hydroxyalkylene group, for instance hydroxymethylene group.

G′ can furthermore encompass, for example, one or more further groups, which serve for example as linkers, i.e. a bridging unit or a bridging segment. For instance, G′ can furthermore encompass at least one benzo group and/or cyclohexano group.

In particular, g′ can denote the number of polymerizable functional groups G′, and in particular it can be the case that 1≤g′, for example 1≤g′≤4, for instance 1≤g′≤2.

For instance, the at least one crown ether and/or the at least one crown ether derivative can respectively encompass a crown ether or crown ether derivative of the general chemical formula:

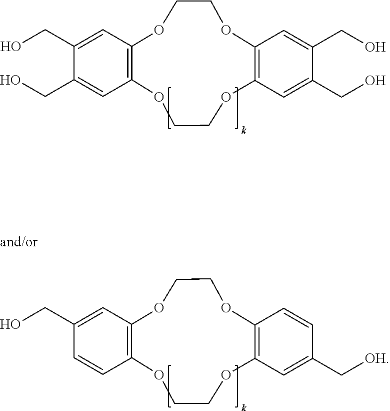

By polymerization, for example via a condensation reaction, in particular etherification, of the hydroxy groups, it is possible to constitute polymers, in particular based on etherified benzo-crown ethers, having respectively crown-ether or crown ether-derivative groups in the polymer backbone, for instance:

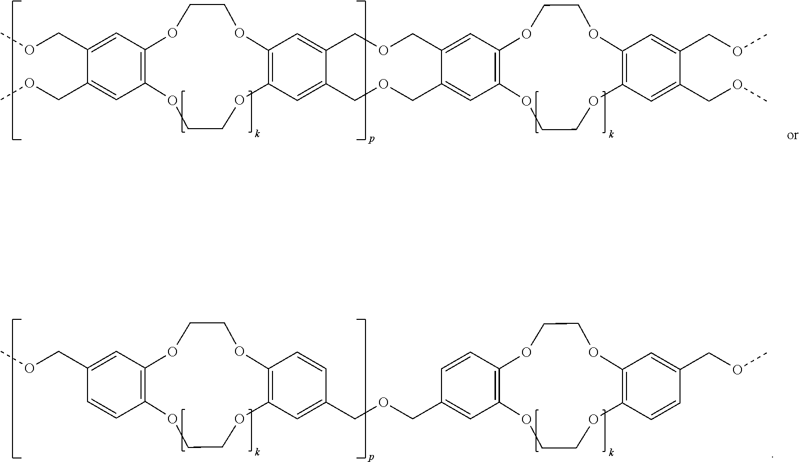

Crown ethers and/or crown ether derivatives of this kind can advantageously be connected, for example covalently, to the anode active material particles, in particular silicon particles, by reaction with at least one silane compound having at least one polymerizable functional group, for example via a condensation reaction.

For instance, a crown ether and a silane compound of the general chemical formulas:

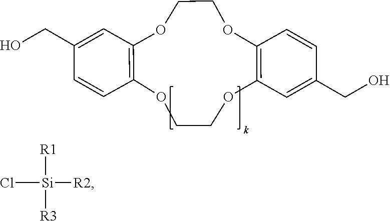

where R1, R2, R3 in particular denote, mutually independently in each case, a halogen atom, in particular chlorine (—Cl), or an alkoxy group, in particular a methoxy group (—OCH₃) or an ethoxy group (—OCH₂H₅), or an alkyl group, for example a linear alkyl group (—(CH₂)ₓ—CH₃) where x≥0, in particular a methyl group (—CH₃), or an amino group (—NH₂, —NH—), or a silazane group (—NH—Si), or a hydroxy group (—OH), or hydrogen (—H), can be connected to one another via a condensation reaction, in particular by reacting the hydroxy group of the crown ether with the chlorine atom of the silane compound, and connected, for example covalently, to the anode active material particles, in particular silicon particles, in particular by reacting R1, R2, and/or R3 of the silane compound with hydroxy groups, for example silicon hydroxide groups or silanol groups (Si—OH) on the surface of the anode active material particles, in particular silicon particles.

In the context of a further embodiment, the at least one crown ether and/or the at least one crown ether derivative furthermore has, in particular in addition to the at least one polymerizable functional group, at least one silane group. For instance, the at least one crown ether and/or the at least one crown ether derivative can encompass respectively a crown ether or crown ether derivative of the general chemical formula:

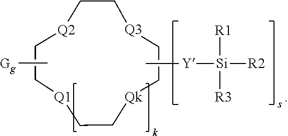

Q1, Q2, Q3, and Qk here can in particular denote, mutually independently in each case, oxygen (O) or nitrogen (N) or an amine, for example a secondary amine (NH) and/or a tertiary amine, for instance an alkylamine or arylamine (NR).

In particular, G can denote at least one polymerizable functional group, for example with which one of the carbon atoms and/or Q1 and/or Q2 and/or Q3 and/or Qk is substituted. In particular, G can encompass at least one polymerizable double bond, for example at least one carbon-carbon double bond, for instance at least one vinyl group and/or vinylidene group and/or vinylene group and/or allyl group, for example allyloxyalkyl group, for instance allyloxymethyl group, and/or at least one hydroxy group, for example hydroxyalkylene group, for instance hydroxymethylene group.

G can furthermore encompass one or more further groups which serve, for example, as linkers, i.e. a bridging unit or bridge segment. For instance, G can furthermore encompass at least one benzo group and/or cyclohexano group.

In particular, g can denote the number of polymerizable functional groups G, and in particular it can be the case that 1≤g, for example 1≤g≤5, for instance 1≤g≤2.

In particular, k can denote the number of units in brackets, and in particular it can be the case that 1≤k, for example 1≤k≤3, for instance 1≤k≤2.

Y′ can denote in particular a linker, i.e. a bridging unit. For example, Y′ can encompass at least one alkylene group (—CₙH₂ₙ—) where n≥0, in particular n≥1, and/or at least one alkylene oxide group (—CₙH₂ₙ—O—) where n≥1, and/or at least one carboxylic acid ester group (—C═O—O—) and/or at least one phenylene group (—C₆H₄—). For instance, Y′ can denote here an alkylene group —CₙH₂ₙ— where 0≤n≤5, for example n=1 or 2 or 3.

In particular, s can denote the number of silane groups (—SiR1R2R3), in particular linked via linker Y′, and it can be the case in particular that 1≤s, for example 1≤s≤5, for instance 1≤s≤2.

R1, R2, R3 can in particular denote, mutually independently in each case, a halogen atom, in particular chlorine (—Cl), or an alkoxy group, in particular a methoxy group (—OCH₃) or an ethoxy group (—OC₂H₅), or an alkyl group, for example a linear alkyl group (—CH₂)ₓ—CH₃) where x≥0, in particular a methyl group (—CH₃), or an amino group (—NH₂, —NH—), or a silazane group (—NH—Si—), or a hydroxy group (—OH), or hydrogen (—H). For instance, R1, R2, and R3 can denote chlorine.

In particular, Q1, Q2, Q3, and Qk can denote oxygen. For example, the at least one crown ether and/or the at least one crown ether derivative can encompass at least one crown ether or crown ether derivative of the general chemical formula:

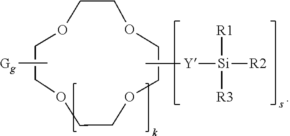

Examples of crown ethers or a crown ether derivative are:

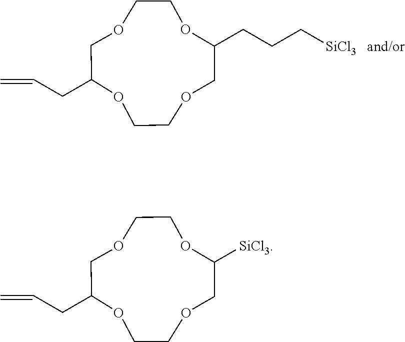

Crown ethers of this kind, or a crown ether derivative, can advantageously attach via the silane group to the anode active material particles, in particular silicon particles, and can additionally serve as a silane-based adhesion promoter.

If the at least one polymerizable monomer encompasses a (di-)aza-crown ether derivative, for instance having a vinyl functionality, (an) NH group(s) can be substituted or equipped, prior to polymerization, with a protective group, for example alkylated, which may be methylated. It is thereby possible to prevent the NH group(s) from interfering with polymerization, for example radical (co)polymerization and/or anionic (co)polymerization. In addition, substituted or tertiary amine groups or N-R bonds can be more resistant to alkali metals.

Alternatively or in addition thereto, however, it is also possible, for example to use a reaction of the NH group(s) of (di-)aza-crown ether derivatives in targeted fashion in the context of polymerization, for instance in order to constitute nitrogen-substituted (di-)aza-crown ether derivative polymers and/or block copolymers, for example by reacting at least one, in particular terminal, polymerizable double bond, for example a vinyl group and/or allyl group, of the at least one (di-)aza-crown ether derivative with at least one polymerizable double bond of at least one further polymerizable monomer or polymer constituted therefrom, for instance with styrene. For this, for instance, the NH group(s) of (di-)aza-crown ether derivatives can be coupled via (CH₂)ₙ bridges in particular by reaction with at least one alpha-omega alkylene compound, and/or alpha-omega diamines, for instance hexamethylenediamine, can be used to synthesize a (di-)aza-crown ether derivative polymer, for example a poly-n-alkylene di-aza-crown ether, for instance of the general chemical formula:

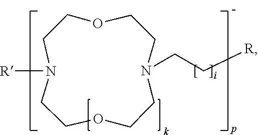

for instance

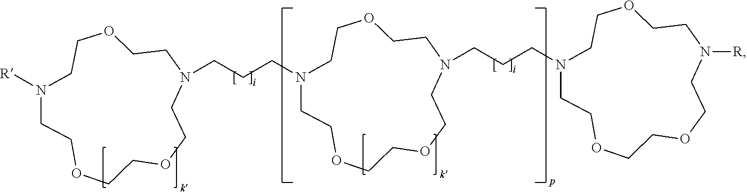

for example where 0≤i≤4.

In the context of an alternative or additional further embodiment, the at least one polymerizable monomer encompasses or is, or the at least two, in particular three, polymerizable monomers encompass, at least one, for example unfluorinated or fluorinated, alkylene oxide, for example ethylene oxide.

In the context of an alternative or additional further embodiment, the at least one polymerizable monomer encompasses or is, or the at least two, in particular three, polymerizable monomers encompass, at least one, for example aliphatic or aromatic, for instance unfluorinated or fluorinated, unsaturated hydrocarbon.

For example, the at least one polymerizable monomer or the at least two, in particular three, polymerizable monomers can encompass or be at least one alkene, for instance ethene, such as 1,1-difluoroethene (1,1-difluoroethylene, vinylidene fluoride) and/or tetrafluoroethylene (TFE), and/or propene, such as hexafluoropropene, and/or hexene, such as 3,3,4,4,5,5,6,6,6-nonafluorohexene, and/or phenylethene, such as 2,3,4,5,6-pentafluorophenylethene (2,3,4,5,6-pentafluorostyrene), and/or 4-(trifluoromethyl)phenylethene (4-(trifluoromethyl)styrene), and/or styrene.

For instance, the at least one polymerizable monomer or the at least two, in particular three, polymerizable monomers can encompass or be at least one fluorinated alkene, for example at least one fluorinated ethene, such as 1,1-difluoroethene (1,1-difluoroethylene, vinylidene fluoride) and/or tetrafluoroethylene (TFE), and/or at least one fluorinated propene, such as hexafluoropropene:

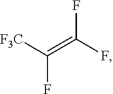

and/or at least one fluorinated hexene, such as 3,3,4,4,5,5,6,6,6-nonafluorohexene:

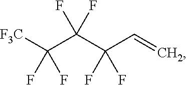 [SMILES: C=CC(F)(F)C(F)(F)C(F)(F)C(F)(F)F]

obtainable, for example, under the commercial name Zonyl PFBE Fluorotelomer Intermediate, and/or at least one fluorinated phenylethene, such as 2,3,4,5,6-pentafluorostyrene:

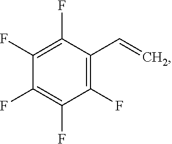 [SMILES: C=Cc1c(F)c(F)c(F)c(F)c1F]

and/or 4-(trifluoromethyl)styrene:

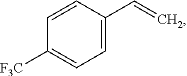 [SMILES: C=Cc1ccc(C(F)(F)F)cc1]

and/or at least one fluorinated vinyl ether, such as 2-(perfluoropropoxy)perfluoropropyltrifluorovinyl ether:

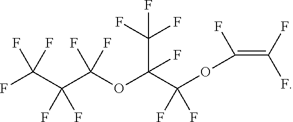 [SMILES: FC(F)=C(F)OC(F)(F)C(F)(OC(F)(F)C(F)(F)C(F)(F)F)C(F)(F)F]

By polymerizing fluorinated alkenes such as 1,1-difluoroethylene, it is advantageously possible to constitute on the particles an artificial SEI layer made of a fluorinated polymer, for example one based on polyvinylidene fluoride (PVdf). Such polymers can advantageously form a gel, for instance in the context of cell assembly and/or battery assembly, in the presence of at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), or of at least one liquid electrolyte, for example based on a, for example 1M, solution of at least one conducting salt, for instance lithium hexafluorophosphate (LiPF₆) and/or bis(trifluoromethane)sulfonimide (LiTFSI) and/or lithium perchlorate (LiClO₄) in at least one electrolyte solvent, for example at least one liquid organic carbonate, such as ethylene carbonate (EC) and/or ethyl methyl carbonate (EMC) and/or dimethyl carbonate (DMC) and/or diethyl carbonate (DEC), and can be used, for example, as a gel electrolyte. It is thereby advantageously possible to constitute, in addition to an artificial SEI protective layer for passivating the anode active material particles, in particular silicon particles, a gel electrolyte coating directly on the anode active material particles, in particular silicon particles. In a first cycle of a cell or battery outfitted therewith, the electrolyte can decompose in the polymer gel matrix of the gel electrolyte coating and can mechanically stabilize the SEI protective layer. This advantageously makes it possible, in the context of cell assembly and/or battery assembly, to dispense with the addition of SEI-stabilizing additives, such as vinylene carbonate (VC) or fluoroethylene carbonate (FEC), in particular to the liquid electrolyte.

Alternatively or additionally, the at least one polymerizable monomer or the at least two, in particular three, polymerizable monomers can encompass or be, for example additionally, at least one unfluorinated alkene, for instance at least one unfluorinated phenylethene, such as styrene.

The use of at least one, for example unfluorinated or fluorinated, phenylethene, for example styrene, in particular copolymerization therewith, advantageously makes it possible to introduce, in particular additionally, hard-segment blocks, for example based on polystyrene, for instance in order to enhance resistance to alkali and/or solvents and/or to improve mechanical properties such as strength. The copolymer can be constructed as a statistical copolymer or as a block copolymer, for instance made up of polystyrene hard segments and soft segments on a different basis, for example poly-crown ether soft segments. Poly-crown ether/polystyrene block copolymers can advantageously represent thermoplastic elastomers, and can exhibit high extensibility.

In the context of a further embodiment, polymerization or reaction of the at least one polymerizable monomer occurs in at least one solvent. Solvent polymerization or solution polymerization advantageously allows better control of the molecular weight of the polymer that is to be constituted. After polymerization or reaction of the at least one polymerizable monomer, the at least one solvent can in particular be removed again.

In the context of a further embodiment, the method is configured to manufacture an anode for a lithium cell and/or lithium battery, in particular for a lithium-ion cell and/or lithium-ion battery.

In the context of an, in particular, so-called “graft-to” embodiment, the at least one polymerizable monomer or the at least two monomers, and/or at least one (co)polymer respectively constituted from the at least one polymerizable monomer or from the at least two polymerizable monomers, can be reacted, for example polymerized, with the at least one silane compound having at least one polymerizable and/or polymerization-initiating and/or polymerization-controlling functional group. Anode active material particles, in particular silicon particles, can then be added.

The reaction can be accomplished in particular by way of a radical polymerization. The radical polymerization can be an, in particular single, radical polymerization, for instance in the presence only of at least one radical initiator, such as AIBN and/or BPO, or, in particular, a living radical polymerization, for example an ATRP, NMP, or RAFT. If at least two polymerizable monomers are used and/or if the at least one polymerizable monomer is used in combination with at least one silane compound having at least one polymerizable functional group, this can involve copolymerization in particular of the at least two polymerizable monomers and/or of the at least one monomer and of the at least one polymerizable functional group of the at least one silane compound.

The reaction of the at least one polymerizable monomer or the at least two monomers, and/or of the at least one polymer respectively constituted from the at least one polymerizable monomer or from the at least two polymerizable monomers, with the at least one silane compound having at least one polymerizable and/or polymerization-initiating and/or polymerization-controlling functional group can be carried out, for example in solution or in at least one solvent, and/or—in particular if the reaction product, for example (co)polymer, formed upon reaction, happens not to be dissolved—the reaction product, for example (co)polymer, formed upon reaction can be dissolved in at least one solvent and/or brought into solution. After addition of the anode active material particles, in particular silicon particles, in particular to the solution, the at least one solvent can then be removed again, for example by evaporation. The anode active material particles, in particular silicon particles, can thereby advantageously be polymer-coated.

The silane function of the at least one silane compound or of the copolymer constituted therefrom can advantageously attach, for example covalently, to the surface of the anode active material particles, in particular silicon particles. The copolymer can thereby, for example, be grafted onto the surface of the anode active material particles, in particular silicon particles.

For instance—in particular if the at least one, in particular adhesion-promoting, silane compound has a polymerizable functional group—the at least one polymerizable monomer or the at least two polymerizable monomers, for example a carboxylic acid and/or a carboxylic acid derivative, such as vinylene carbonate, and/or an ether, such as a crown ether and/or crown ether derivative, can be reacted, in particular copolymerized, with the at least one silane compound having at least one polymerizable and/or polymerization-initiating and/or polymerization-controlling functional group, for instance with at least one, in particular adhesion-promoting, silane compound having at least one polymerizable functional group, for example a vinyl silane, such as trichlorovinyl silane, for example by addition of at least one polymerization initiator, for instance by addition of at least one radical initiator, possibly in solution or in at least one solvent, to yield a copolymer. Linkage, for example radical attachment, of the silane function to the polymer can thus advantageously be ensured. If the copolymer happens not to be dissolved, it can be brought into solution. The anode active material particles, in particular silicon particles, can then be added. The silane function, for example trichlorosilane, of the at least one silane compound or of the copolymer constituted therefrom can in that context advantageously attach, for example covalently, to the surface of the anode active material particles, in particular silicon particles.

Or, for instance - in particular if the at least one, in particular adhesion-promoting, silane compound has a polymerizable functional group—the at least one polymerizable monomer or the at least two polymerizable monomers, for instance a carboxylic acid and/or a carboxylic acid derivative such as vinylene carbonate, and/or an ether such as a crown ether and/or crown ether, can be reacted, for example by adding at least one polymerization initiator, for instance by adding at least one radical initiator, possibly in solution or in at least one solvent, to yield a polymer. If the polymer happens not to be dissolved, it can be brought into solution. The polymer constituted from the at least one polymerizable monomer or from the at least two polymerizable monomers can then be reacted with the at least one silane compound having at least one polymerizable and/or polymerization-initiating and/or polymerization-controlling functional group, for instance with at least one, in particular adhesion-promoting, silane compound having at least one polymerizable functional group, for example a vinyl silane such as trichlorovinyl silane, for example by again adding the at least one polymerization initiator, for instance radical initiator. The at least one silane compound having at least one polymerizable and/or polymerization-initiating and/or polymerization-controlling functional group can thereby advantageously be linked to the polymer constituted from the at least one polymerizable monomer or from the at least two polymerizable monomers. Linkage, for example radical attachment, of the silane function to the polymer function can thereby advantageously be ensured. The anode active material particles, in particular silicon particles, can then be added. The silane function, for instance trichlorosilane, of the at least silane compound, or the copolymer constituted therefrom, can in that context advantageously attach to the surface of the anode active material particles, in particular silicon particles.

If the at least one silane compound has a polymerization-initiating functional group, in particular for initiating an atom transfer living radical polymerization (ATRP initiator), the reaction of the at least one polymerizable monomer or the at least two polymerizable monomers, for example a carboxylic acid and/or a carboxylic acid derivative such as vinylene carbonate, and/or an ether such as a crown ether and/or crown ether derivative, with the at least one silane compound having the polymerization-initiating functional group can be carried out in particular in the presence of at least one catalyst, for example at least one transition metal halide, for instance a copper halide, and optionally at least one ligand, for instance a nitrogen ligand (N-type ligand), such as tris[2-(dimethylamino)ethyl]amine. Polymerization can thereby advantageously be initiated.

If the at least one silane compound has a polymerization-controlling functional group, in particular for nitroxide-mediated polymerization (NMP mediator) or for reversible addition-fragmentation chain transfer polymerization (RAFT agent), the reaction of the at least one polymerizable monomer or the at least two polymerizable monomers, for example a carboxylic acid and/or a carboxylic acid derivative such as vinylene carbonate, and/or an ether such as a crown ether and/or crown ether derivative, with the at least one silane compound having the polymerization-controlling functional group can be carried out in particular in the presence of at least one polymerization initiator, for example radical initiator, for instance AIBN or BPO. In order to further improve polymerization control, at least one polymerization-controlling agent, in particular for nitroxide-mediated polymerization (NMP mediator) and/or for reversible addition-fragmentation chain transfer polymerization (RAFT agent), for example at least one nitroxide-based mediator, for instance a sacrificial initiator in the form of an alkoxyamine, or at least one thio compound, can if applicable also be added.

In the context of a further embodiment, the anode active material particles, in particular silicon particles, that are equipped, in particular coated, with the polymer are mixed with at least one further electrode component and processed, for example by blade-coating, to yield an anode. The artificial SEI layer can thereby advantageously be constituted in targeted fashion on the anode active material particles, in particular silicon particles, and, for example, the quantity of the at least one polymerizable monomer necessary for coating the anode active material particles, in particular silicon particles, can be minimized.

In the context of the preceding embodiment, the at least one further electrode component can encompass at least one carbon component, for example graphite and/or conductive carbon black, and/or at least one, if applicable additional, for example compatible, binder, for instance carboxymethyl cellulose (CMC) and/or carboxymethyl cellulose salts such as lithium carboxymethyl cellulose (LiCMC) and/or sodium carboxymethyl cellulose (NaCMC) and/or potassium carboxymethyl cellulose (KCMC), and/or polyacrylic acid (PAA) and/or polyacrylic acid salts such as lithium polyacrylic acid (LiPAA) and/or sodium polyacrylic acid (NaPAA) and/or potassium polyacrylic acid (KPAA), and/or polyvinyl alcohol (PVAL), and/or styrene/butadiene rubber (SBR), and/or at least one solvent.

In particular, the at least one, if applicable additional, binder can have carboxylic acid groups (—COOH) and/or hydroxy groups (—OH). For instance, the at least one, if applicable additional, binder can encompass or be polyacrylic acid (PAA) and/or carboxymethyl cellulose (CMC) and/or polyvinyl alcohol (PVAL).

In particular, the at least one polymerizable monomer and/or the polymer constituted from the at least polymerizable monomer can have carboxylic acid groups (—COOH) and/or hydroxy groups (—OH). For instance, the at least one polymerizable monomer can encompass or be acrylic acid and/or vinyl acetate, and/or the polymer constituted from the at least one polymerizable monomer can encompass or be a polyacrylic acid-based (PAA-based) polymer obtainable by polymerization of acrylic acid, and/or a polyvinyl alcohol (PVAL) obtainable by polymerization of vinyl acetate with subsequent saponification.

If both the at least one, if applicable additional, binder and the at least one polymerizable monomer and/or the polymer constituted from the at least one monomer encompasses carboxylic acid groups (—COOH) and/or hydroxy groups (—OH), anode active material particles, in particular silicon particles, that are equipped, for example coated, with the polymer can advantageously be connected covalently, via a condensation reaction, to the at least one binder. An anhydride compound can be arrived at by way of a condensation reaction between two carboxylic acid groups. An ester compound can be arrived at by way of a condensation reaction between a carboxylic acid group and a hydroxy group. An ether compound can be arrived at by way of a condensation reaction between two hydroxy groups.

For instance, silicon particles equipped with a polymer based on polyacrylic acid (Si-PAA) can be covalently connected to polyacrylic acid (PAA) and/or carboxymethyl cellulose (CMC) and/or polyvinyl alcohol (PVAL) as binder, via a condensation reaction, in accordance with the following patterns:

Si-PAA+PAA: —COOH+—COOH—> anhydride compound

Si-PAA+CMC: —COOH+—COOH—> anhydride compound

Si-PAA+PVAL: —COOH+—OH—> ester compound

If applicable, in particular if the polymer constituted from the polymerizable monomer can also serve as a binder, the addition of at least one, in particular additional, binder as a further electrode component can be dispensed with, or the at least one further electrode component can, if applicable, also be configured in binder-free fashion.

It is nevertheless possible, for example in order to improve the mechanical stability and/or conductivity of the anode that is to be constituted, to use at least one, for example additional, binder, in particular one different from the polymer constituted from the polymerizable monomer, as a further electrode component.

If applicable, the at least one solvent used in the context of polymerization can also serve as an electrode component, for example in order to constitute an electrode slurry. The addition of an additional solvent as a further electrode component can thus, if applicable, be dispensed with.

In particular, however, for example if the at least one solvent is removed again after polymerization, at least one solvent, in particular one different from the solvent for polymerization, can be used as a further electrode component.

With regard to further technical features and advantages of the method according to the present invention, reference is herewith explicitly made to the explanations in conjunction with the anode active material according to the present invention, the anode according to the present invention, and the cell and/or battery according to the present invention, and to the Figures and the description of the Figures.

Further subjects of the present invention are an anode active material and/or an anode, for a lithium cell and/or lithium battery, in particular for a lithium-ion cell and/or lithium-ion battery, which is manufactured by way of a method according to the present invention.

An anode active material according to the present invention or manufactured according to the present invention, for example made of the polymer, for instance polyvinylene carbonate, constituted from the at least one polymerizable monomer, and/or an anode according to the present invention or manufactured according to the present invention, can be documented, for example, by nuclear magnetic resonance (NMR) spectroscopy and/or infrared (IR) spectroscopy and/or Raman spectroscopy. An anode active material according to the present invention or manufactured according to the present invention, and/or an anode according to the present invention and/or manufactured according to the present invention, can furthermore be documented, for example, using surface analysis methods, such as Auger electron spectroscopy (AES) and/or X-ray photoelectron spectroscopy (XPS) and/or time-of-flight secondary ion mass spectrometry (TOF-SIMS) and/or energy-dispersive X-ray spectroscopy (EDX) and/or wavelength-dispersive X-ray spectroscopy (WDX), for instance EDX/WDX, and/or by way of structural investigation methods such as transmission electron microscopy (TEM), and/or by way of cross-sectional investigations such as scanning electron microscopy (SEM) and/or energy-dispersive X-ray spectroscopy (EDX), for instance SEM-EDX, and/or transmission electron microscopy (TEM) and/or electron energy loss spectroscopy (EELS), for instance TEM-EELS. Transition metals contained in an ATRP catalyst and/or nitroxide-based mediators such as TEMPO, and/or RAFT chemicals, among others, can thereby, for instance, be documentable.

With regard to further technical features and advantages of the anode active material according to the present invention and the anode according to the present invention, reference is herewith explicitly made to the explanations in conjunction with the method according to the present invention and the cell and/or battery according to the present invention, and to the Figures and the description of the Figures.

The invention further relates to a lithium cell and/or lithium battery, in particular a lithium-ion cell and/or lithium-ion battery, which is manufactured by way of a method according to the present invention and/or encompasses an anode active material according to the present invention and/or an anode according to the present invention.

With regard to further technical features and advantages of the cell and/or battery according to the present invention, reference is herewith explicitly made to the explanations in conjunction with the method according to the present invention, the anode active material according to the present invention, and the anode according to the present invention, and to the Figures and the description of the Figures.

Further advantages and advantageous embodiments of the subject matters of the present invention are illustrated by the drawings and explained in the description below. In this context, the drawings are merely descriptive in nature and are not intended to limit the invention in any way.

### BRIEF DESCRIPTION OF THE DRAWINGS

FIG. 1a is a flow chart to illustrate an embodiment of the manufacturing method according to the present invention.

FIG. 1b is a schematic cross section through an anode that is manufactured in accordance with the embodiment of the method according to the present invention shown in FIG. 1a.

### DETAILED DESCRIPTION

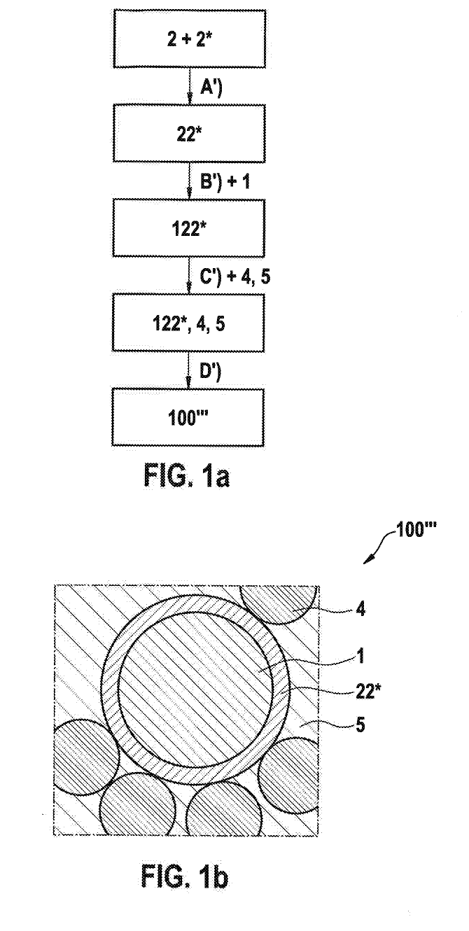

FIG. 1a illustrates that in the context of an embodiment of the method according to the present invention, for example in a method step A′), at least one polymerizable monomer 2, for instance vinylene carbonate, and/or at least one polymer constituted from the at least one polymerizable monomer 2, for instance polyvinylene carbonate, is reacted, for example polymerized, with at least one silane compound 2* having at least one polymerizable and/or polymerization-initiating and/or polymerization-controlling functional group. The at least one silane compound 2* can be, for example, a vinyl silane or a silane-based ATRP initiator or a silane-based NMP mediator or a silane-based RAFT agent.

A (co)polymer 22* is formed in this context, and anode active material particles, in particular silicon particles, 1 are then added to 22*, for example in a method step B′). In this context, the silane function of the (co)polymer 22* constituted upon reaction enters into an, in particular covalent, bond with the anode active material particles, in particular silicon particles, 1, for example by way of a condensation reaction with hydroxy groups, for example silicon hydroxide groups or silanol groups (Si—OH), on the surface of the anode active material particles, in particular silicon particles, 1, and the anode active material particles, in particular silicon particles, 1 are thereby coated.

The polymerization can be, in particular, a radical polymerization. For instance, a vinyl silane and/or vinylene carbonate (VC) can be polymerized by way of a silane-based ATRP initiator and/or by addition of a polymerization initiator, for example a radical initiator, for instance azoisobutyronitrile (AIBN) and/or benzyl peroxide (BPO), by radical polymerization, for example to yield polyvinylene carbonate; in the special case of living radical polymerization, for instance ATRP, a silane-based ATRP initiator and/or an alkyl halide (RX), in combination with a catalyst constituted from a transition metal halide (MX) and ligands (L), or, for instance, an NMP, a silane-based NMP mediator and/or nitroxide-based mediator (TEMPO) in combination with a radical initiator, such as AIBN, or, for instance, a RAFT, a silane-based RAFT agent and/or thio compound (Thio), in combination with a radical initiator such as AIBN, can be used:

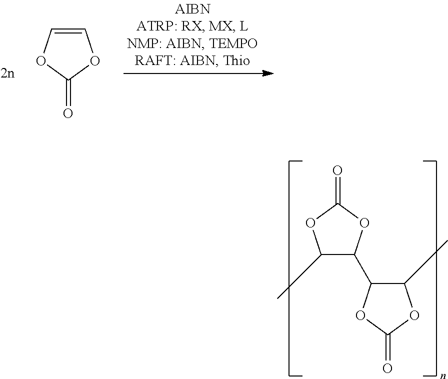

The coated anode active material particles, in particular silicon particles, 122* can then be mixed, for example in a method step C′), with one or more further electrode components, such as graphite and/or conductive carbon black 4 and binder 5 and/or solvent, and the mixture 122*, 4, 5 can be processed, for example blade-coated, for example in a method step D′), to yield an anode 100′″. Binder 5 that serves as a further electrode component can, if applicable, be different from polymer 22* constituted from polymerizable monomer 2.

FIG. 1b illustrates that a correspondingly manufactured anode 100′″ can encompass anode active material particles, in particular silicon particles, 1 coated with polymer 22*, as well as graphite particles and/or conductive carbon black particles 4 that are embedded in an additional binder 5.

1-23. (canceled)

24. A method for manufacturing an anode active material and/or an anode for a lithium cell and/or lithium battery, in particular for a lithium-ion cell and/or lithium-ion battery, and/or for manufacturing a lithium cell and/or lithium battery, in particular a lithium-ion cell and/or lithium-ion battery, the method comprising:
reacting at least one polymerizable monomer, and/or at least one polymer constituted from the at least one polymerizable monomer, with at least one silane compound having at least one polymerizable and/or polymerization-initiating and/or polymerization-controlling functional group, and
adding anode active material particles, in particular silicon particles.

25. The method of claim 24, wherein at least two polymerizable monomers, and/or a copolymer constituted from at least two polymerizable monomers, are used.

26. The method of claim 24, wherein the at least one polymerizable functional group of the at least one silane compound and/or the at least one polymerizable monomer, in particular the at least two polymerizable monomers, encompasses at least one polymerizable double bond and/or at least one hydroxy group.

27. The method of claim 24, wherein:
the at least one polymerizable functional group of the at least one silane compound and/or the at least one polymerizable monomer, in particular the at least two polymerizable monomers, being polymerizable by radical polymerization, in particular by living radical polymerization, and/or the at least one polymerization-initiating functional group of the at least one silane compound is configured to initiate a radial polymerization, in particular to initiate a living radical polymerization, and/or
the at least one polymerization-controlling functional group of the at least one silane compound is configured to control a living radical polymerization.

28. The method of claim 24, wherein:
the at least one polymerizable functional group of the at least one silane compound and/or the at least one polymerizable monomer, in particular the at least two polymerizable monomers, is polymerizable by atom transfer living radical polymerization or by stable free radical polymerization, in particular by nitroxide-mediated polymerization or by reversible addition-fragmentation chain transfer polymerization, and/or
the at least one polymerization-initiating functional group of the at least one silane compound is configured to initiate an atom transfer living radical polymerization, and/or
the at least one polymerization-controlling functional group of the at least one silane compound is configured to control a stable free radical polymerization, in particular to control a nitroxide-mediated polymerization, and/or to control a reversible addition-fragmentation chain transfer polymerization.

29. The method of claim 24, wherein the at least one polymerizable functional group of the at least one silane compound and/or the at least one polymerizable monomer, in particular the at least two polymerizable monomers, encompass at least one polymerizable double bond, in particular at least one carbon-carbon double bond.

30. The method of claim 24, wherein the at least one polymerization-initiating functional group of the at least one silane compound encompasses an alkyl group substituted with at least one halogen atom, in particular bromine or chlorine.

31. The method of claim 24, wherein the at least one polymerization-initiating functional group of the at least one silane compound are used in combination with at least one catalyst, in particular the at least one catalyst encompassing or being constituted from a transition metal halide and at least one ligand, in particular nitrogen ligand.

32. The method of claim 24, wherein the at least one polymerization-controlling functional group of the at least one silane compound encompasses, in particular for nitroxide-mediated polymerization, a nitroxide group and/or alkoxyamine group and/or, in particular for reversible addition-fragmentation chain transfer polymerization, a thio group.

33. The method of claim 24, wherein the at least one polymerization-controlling functional group of the at least one silane compound (2*) being used in combination with at least one polymerization initiator and/or with at least one polymerization-initiating functional group of at least one silane compound (2*).

34. The method of claim 24, wherein the polymerization of the at least one polymerizable monomer, in particular of the at least two polymerizable monomers, are initiated by the at least one polymerization-initiating functional group of the at least one silane compound and/or by, in particular by addition of, at least one polymerization initiator.

35. The method of claim 24, wherein the at least one polymerization-initiating functional group of the at least one silane compound, and/or the at least one polymerization initiator, is a radical initiator.

36. The method of claim 24, wherein the at least one silane compound encompasses at least one silane compound of the general chemical formula: 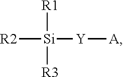
where
R1, R2, R3, mutually independently in each case, denote a halogen atom or an alkoxy group or an alkyl group or an amino group or a silazane group or a hydroxy group or hydrogen,
Y denotes a linker, in particular where Y encompasses at least one alkylene group and/or at least one alkylene oxide group and/or at least one carboxylic acid ester group and/or at least one phenylene group, and
A denotes a polymerizable and/or polymerization-initiating and/or polymerization-controlling functional group.

37. The method of claim 36, wherein:
A denotes a polymerizable functional group having at least one polymerizable double bond, in particular a vinyl group or a vinylidene group or a vinylene group or an acrylate group or a methacrylate group, or
A denotes a polymerization-initiating functional group for initiating an atom transfer living radical polymerization, in particular bromine or chlorine, or
A denotes a polymerization-controlling functional group for nitroxide-mediated polymerization, in particular a nitroxide group and/or alkoxyamine group, or a polymerization-controlling functional group for reversible addition-fragmentation chain transfer polymerization, in particular a thio group.

38. The method of claim 24, wherein the anode active material particles encompasses and/or are silicon particles and/or graphite particles and/or tin particles, in particular silicon particles.

39. The method of claim 24, wherein the at least one polymerizable monomer, in particular the at least two polymerizable monomers, encompasses:
at least one polymerizable carboxylic acid, and/or
at least one polymerizable carboxylic acid derivative, in particular at least one polymerizable organic carbonate and/or anhydride, and/or
at least one carboxylic acid ester, and/or
at least one carboxylic acid nitrile, and/or
at least one ether, in particular at least one crown ether and/or at least one crown ether derivative and/or at least one vinyl ether, and/or
at least one, in particular aliphatic or aromatic, unsaturated hydrocarbon.

40. The method of claim 24, wherein the at least one polymerizable monomer, in particular the at least two polymerizable monomers, further encompassing at least one unfluorinated alkylene oxide group and/or at least one fluorinated alkylene oxide group and/or at least one fluorinated alkoxy group and/or at least one fluorinated alkyl group and/or at least one fluorinated phenyl group.

41. The method of claim 24, wherein the at least one polymerizable monomer, in particular the at least two polymerizable monomers, encompasses or is acrylic acid and/or methacrylic acid and/or vinylene carbonate and/or vinyl ethylene carbonate and/or maleic acid anhydride and/or poly(ethylene glycol) methyl ether acrylate and/or methyl methacrylate and/or vinyl acetate and/or acrylonitrile and/or at least one crown ether and/or at least one crown ether derivative having at least one polymerizable functional group, in particular having at least one polymerizable double bond, and/or having at least one hydroxy group, and/or a trifluorovinyl ether and/or 1,1-difluoroethene and/or hexafluoropropene and/or 3,3,4,4,5,5,6,6,6-nonafluorohexene and/or 2,3,4,5,6-pentafluorophenylethene and/or 4-(trifluoromethyl)phenylethene and/or styrene, and/or a derivative thereof.

42. The method of claim 39, wherein the at least one crown ether and/or the at least one crown ether derivative encompassing a crown ether or a crown ether derivative of the general chemical formula: 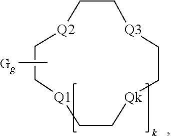
where Q1, Q2, Q3, and Qk denote, mutually independently in each case, oxygen or nitrogen or an amine, in particular oxygen,
where G denotes at least one polymerizable functional group, in particular where G encompasses at least one vinyl group and/or at least one vinylidene group and/or at least one vinylene group and/or at least one allyl group and/or at least one hydroxy group, in particular where G furthermore encompasses at least one benzo group and/or cyclohexanone group,
where g denotes the number of polymerizable functional groups G, and
where k denotes the number of units in brackets.

43. The method of claim 39, wherein the at least one crown ether and/or the at least one crown ether derivative encompassing a crown ether or a crown ether derivative of the general chemical formula: 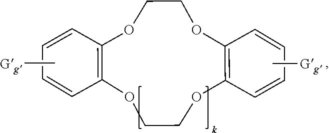
where G′ denotes at least one polymerizable functional group, in particular at least one vinyl group and/or at least one vinylidene group and/or at least one vinylene group and/or at least one allyl group and/or at least one hydroxy group, and where 1≤g′.

44. The method of claim 24, wherein the at least one silane compound encompasses at least one silane compound, at least one crown ether-based silane compound of the general chemical formula; and/or the at least one crown ether and/or the at least one crown ether derivative encompasses a crown ether or a crown ether derivative of the general chemical formula: 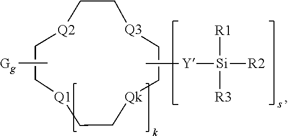
where
R1, R2, R3, mutually independently in each case, denote a halogen atom or an alkoxy group or an alkyl group or an amino group or a silazane group or a hydroxy group or hydrogen, Q1, Q2, Q3, and Qk, mutually independently in each case, denote oxygen or nitrogen or an amine,
k denotes the number of units in brackets,
G denotes at least one polymerizable functional group, in particular where G encompasses at least one carbon-carbon double bond, in particular at least one vinyl group and/or vinylidene group and/or vinylene group and/or allyl group and/or at least one hydroxy group,
g denotes the number of polymerizable functional groups G,
Y′ denotes a linker, in particular denotes —CₙH₂ₙ— where n=1 or 2 or 3, and
s denotes the number of silane groups, in particular those attached via the linker Y′.

45. An anode active material and/or anode for a lithium cell and/or lithium battery, in particular for a lithium-ion cell and/or lithium-ion battery, comprising:
an anode active material and/or anode which includes:
a reaction product of at least one polymerizable monomer, and/or at least one polymer constituted from the at least one polymerizable monomer, with at least one silane compound having at least one polymerizable and/or polymerization-initiating and/or polymerization-controlling functional group, and
anode active material particles, in particular silicon particles.

46. A lithium cell and/or lithium battery, in particular a lithium-ion cell and/or lithium-ion battery, comprising:
an anode active material and/or anode for a lithium cell and/or lithium battery, in particular for a lithium-ion cell and/or lithium-ion battery, including an anode active material and/or anode which includes:
a reaction product of at least one polymerizable monomer, and/or at least one polymer constituted from the at least one polymerizable monomer, with at least one silane compound having at least one polymerizable and/or polymerization-initiating and/or polymerization-controlling functional group, and
anode active material particles, in particular silicon particles.
